(19) United States
(12) Patent Application Publication
(10) Pub. No.: US 2016/0196627 A1
(43) Pub. Date: Jul. 7, 2016

(54) SYSTEM AND METHOD FOR COMPREHENSIVE INVENTION DISCLOSURE

(71) Applicant: Eric Leininger, New Orleans, LA (US)

(72) Inventor: Eric Leininger, New Orleans, LA (US)

(21) Appl. No.: 14/909,421

(22) PCT Filed: Aug. 2, 2014
(86) PCT No.: PCT/US14/49510

§ 371 Date: Feb. 1, 2016

Related U.S. Application Data
(60) Provisional application No. 61/861,559, filed on Aug. 2, 2013.

(51) Int. Cl. G06Q 50/18; G06F 3/0486

(52) U.S. Cl. CPC G06Q 50/184; G06F 3/0486

(57) ABSTRACT

This invention allows one to create natural text from this disclosure information, which may be used to help prepare a patent application more rapidly for patent professionals and in some instances a trained layperson inventor. The disclosure information is entered into an interface on a computer.

### CROSS-REFERENCE TO RELATED APPLICATIONS

This application claims priority to Provisional application No. 61/861,559

### STATEMENT REGARDING FEDERALLY FUNDED RESEARCH

Not Applicable

### REFERENCE TO A MICROFICHE APPENDIX

Not applicable

### BACKGROUND OF THE INVENTION

1. Field of the Invention/Technical Field

The present invention is in the technical field of business methods for intellectual property

2. Description of Related Art/Background Art

In the age of the internet people's daily experiences are broadening. Widely available, instantly accessible information has led to a diversity of peoples unique experiences and with that, interactions within multiple arts in their daily lives. It is now possible for people without a formal education to began to have hyper-specialized skills across multiple arts (programming, communication, business) and this hyper specialization leads to opportunities and innovations that can rapidly grow economies, provide jobs and produce more efficient products and services than ever before. Patent protection is an important part of the comfort of these peoples to disclose their inventions to the world, in exchange for a limited exclusive marketplace opportunity.

Currently, preparing a patent application (in the US) is the work of about ˜40,000 professionals such as patent attorneys and patent agents. Rapid innovation is creating considerable demand for their services and method to accommodate this demand would greatly benefit their industry and society. However, there remain numerous impediments to the actual disclosure of inventions to the general public.

Patent claims have a definitive structure and are composed of parts, limitations, steps and in some cases functions. A disclosure method that enhances the average layperson ability to rigorously disclose and organize their invention would be of great benefit to practitioners and to the layperson alike. It also would likely decrease demand for “invention-companies”. Further, if there was a means to consolidate invention data in a definitive format it may make understanding of the invention itself easier and examination of the invention versus prior art, especially in terms of relevant combinations as with 103(a) obviousness rejections. Further, if this system were further endowed with the ability to produce natural text from the disclosure it could greatly speed the process of application preparation for professionals leading to cheaper and better patent applications for them and inventors alike.

### SUMMARY OF THE INVENTION

It is highly variable but specific iterations of an invention is the hallmark of professional patent application preparation. This invention is a both a system and a method of using said system that greatly enhances ones ability to rapidly disclose and prepare patent applications. An broad description of this invention is that it is a graphical method of writing all possible patent claims. More specifically it is a rigorous, scalable, flexible and editable disclosure means that allows one to create very specific, but wide-ranging and highly variable embodiments. In addition, this invention is capable of distilling the disclosure information, into a regularly structured transmissible format for evaluation, searching and modification. Further, this invention allows one to create natural text from this disclosure information, which may be used to help prepare a patent application more rapidly for patent professionals and in some instances a trained layperson inventor.

It is an object of this invention to create an easy way for the non-patent professional to understand what an invention is in terms of the law.

It is yet another object of this invention to create an easily understandable teaching method of the structure of patent claims.

It is yet another object of this invention to have an easily adjustable patent application narrative, done by means of dragging and dropping elements in the interface.

It is yet another object of this invention to have an intuitive manner in which to create the syntax for an invention's parts.

It is yet another object of this invention to create a very detailed patent application, by simply going over the list of potential properties for each element

It is yet another object of this invention to provide a means to review an invention for prior art by examining the disclosure data generated by the invention

It is yet another object of this invention to provide a means to have an invention information be easily understood and transmittable

It is yet another object of this invention to create a more accurate representation of the invention than would typically be possible by a layman

It is yet another object of this invention to have less information lost in the translation when disclosing information to a patent professional who may not be as familiar in the art as the inventor.

It is yet another object of this invention to help overcome obviousness rejections by clear statements of reasons for combinations of parts that may not be taught in the prior art.

It is yet another object of this invention to help create a laypersons understanding of a means plus function claim

It is important for one to understand that this invention has been reduced to practice and numerous evidences of possession, function, capability and failed experiments (evidence of non-obvious combination as in this invention being functional) have been gathered by the inventor. Further, secondary evidences such as impact on the market place, use of the product by others, and enhanced capability for the inventor layperson are planned on being gathered after filing. In exchange for this public disclosure and the ultimate benefits of understanding how it works (which may be applicable to other processes besides patent applications), the inventor requests a brief exclusive right to sell (a patent) and continue to develop this invention rather than keeping it a trade secret.

### BRIEF DESCRIPTION OF THE DRAWINGS

FIG. 1 is a system diagram view that shows network communication of an embodiment of the invention.

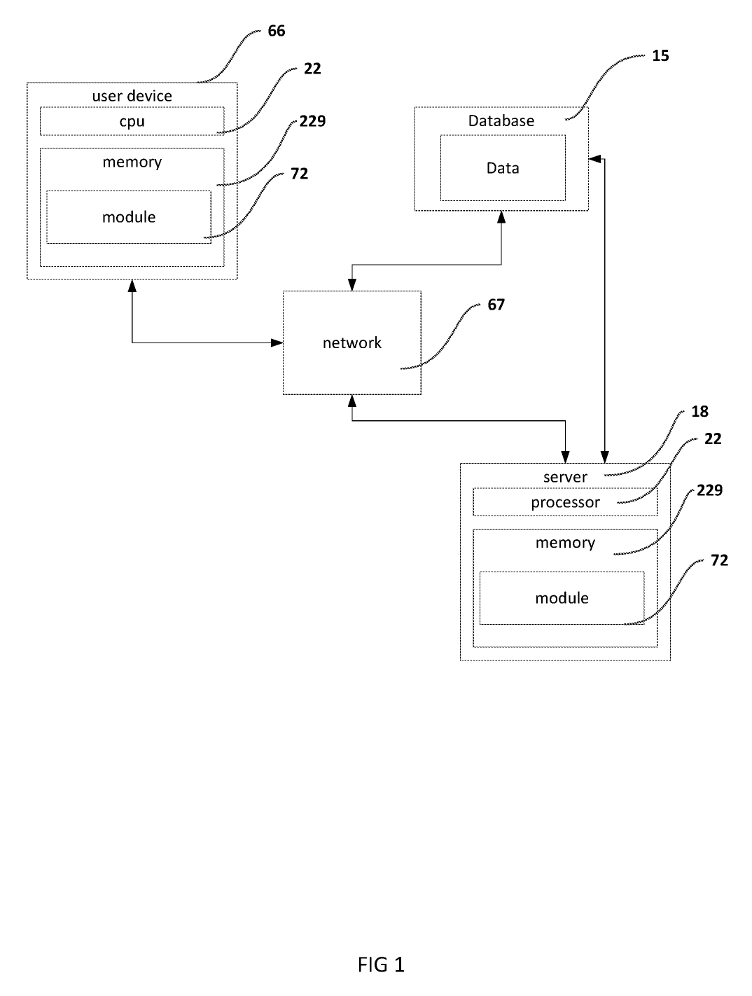

FIG. 2 is a diagram view that shows the presence of the modules on the user device or server.

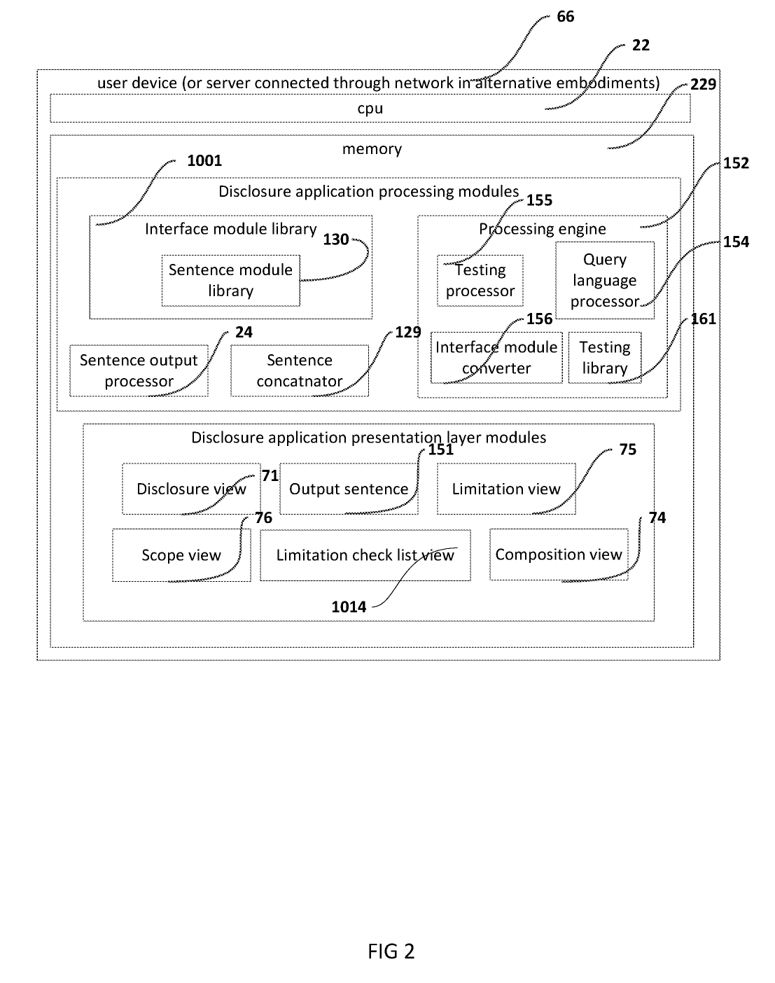

FIG. 3 is a diagram view that shows an embodiment of the disclosure application where interfaces and sentences are created by interface modules from a interface module library.

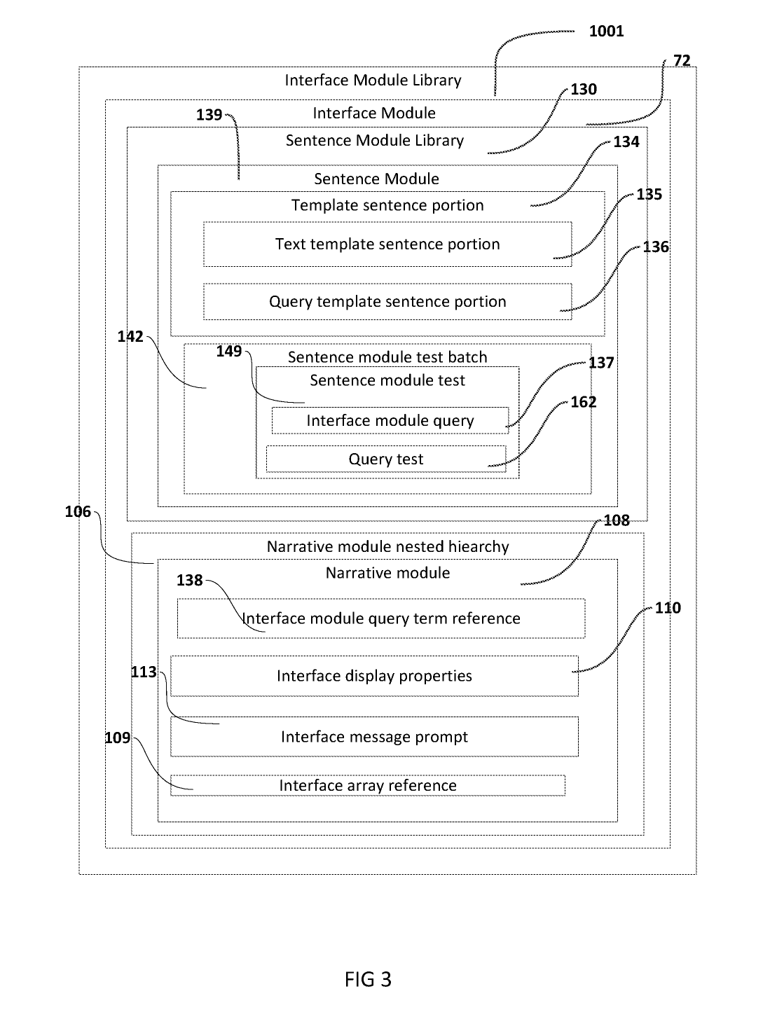

FIG. 4 is a diagram view that shows the interface module converter that parses interfaces modules to create the disclosure application.

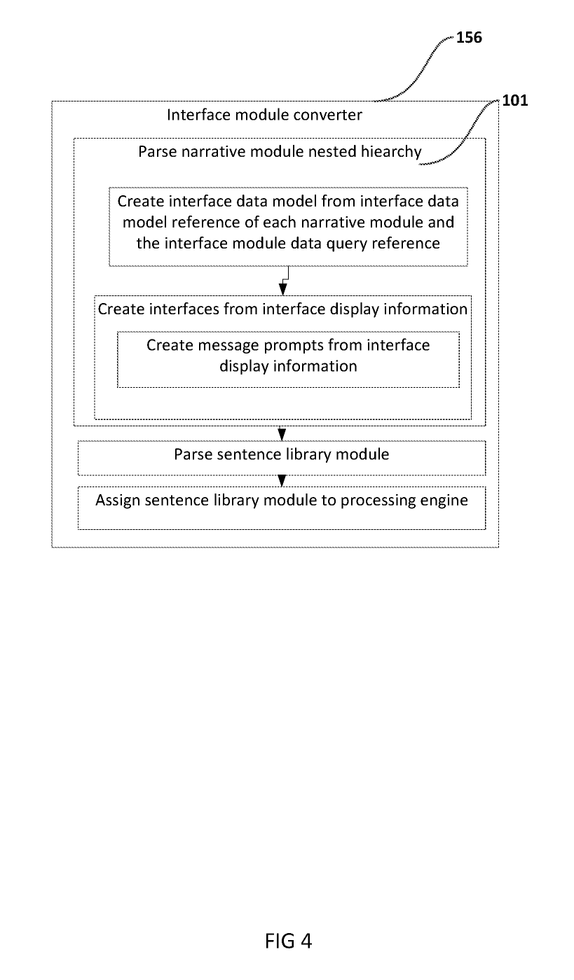

FIG. 5 is a flowchart view that shows the steps the processing engine incurs to determine the output sentences when the user types in data.

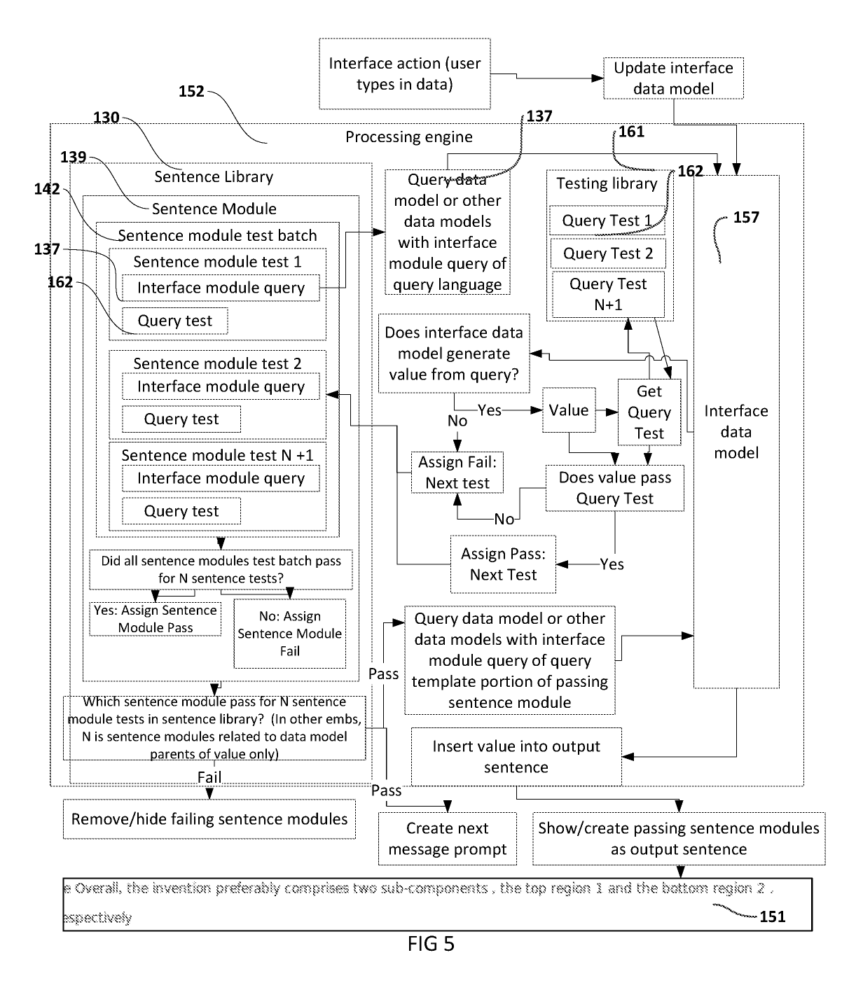

FIG. 6 is a mindmap relational view that shows a sentence module library where the sentence modules are referred to by their library reference.

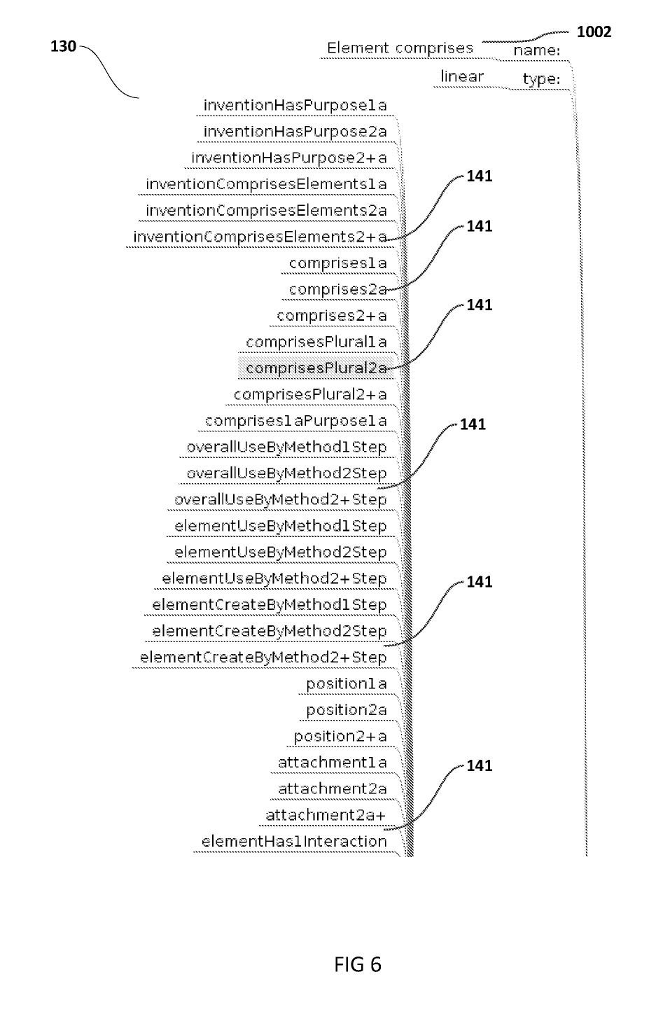

FIG. 7 is a mindmap relational view that shows the components of an individual sentence module.

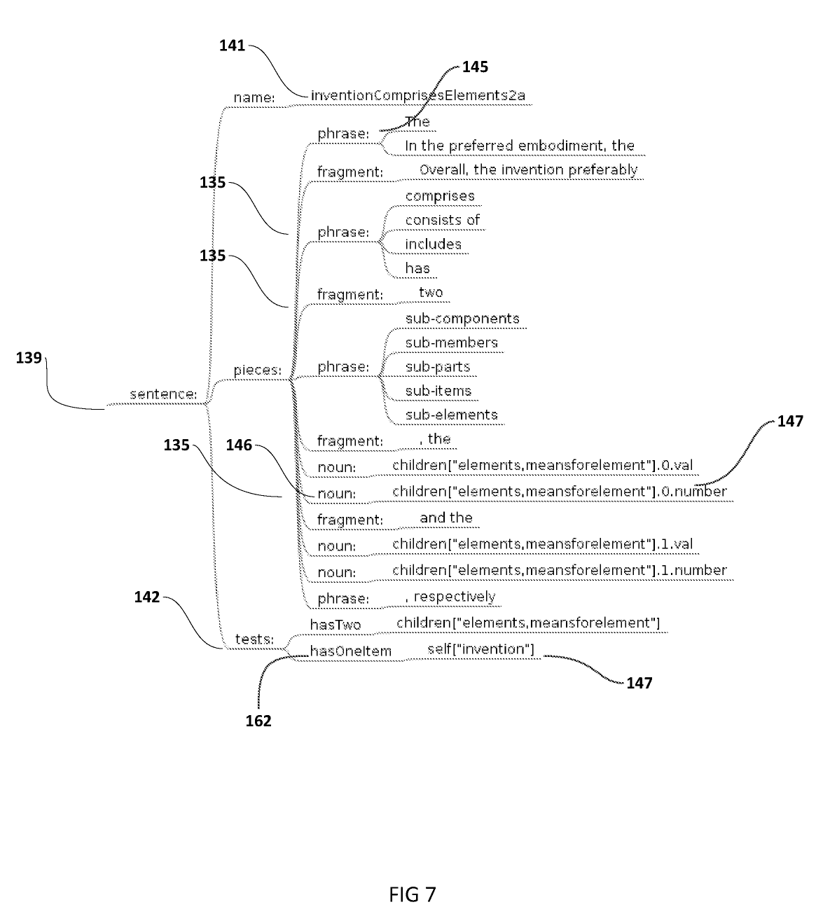

FIG. 8 is a mindmap relational view that shows an interface module which has nested narrative modules underneath it.

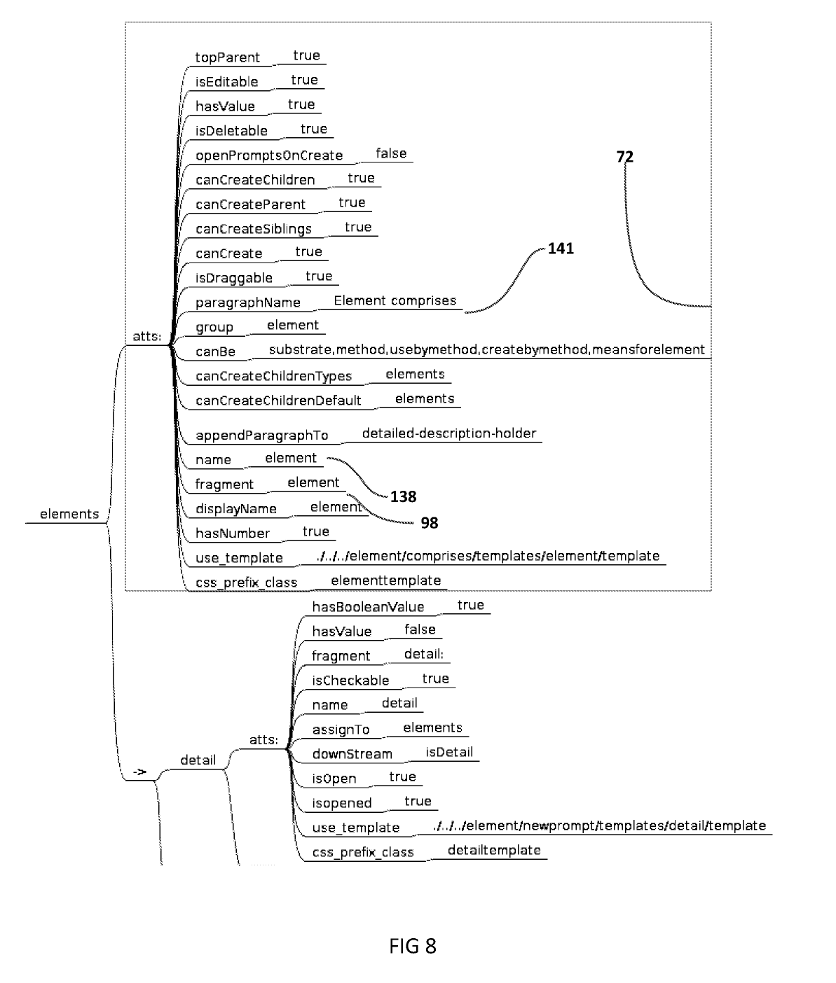

FIG. 9 is a mindmap relational view that shows a nested module hierarchy within an interface module and its properties.

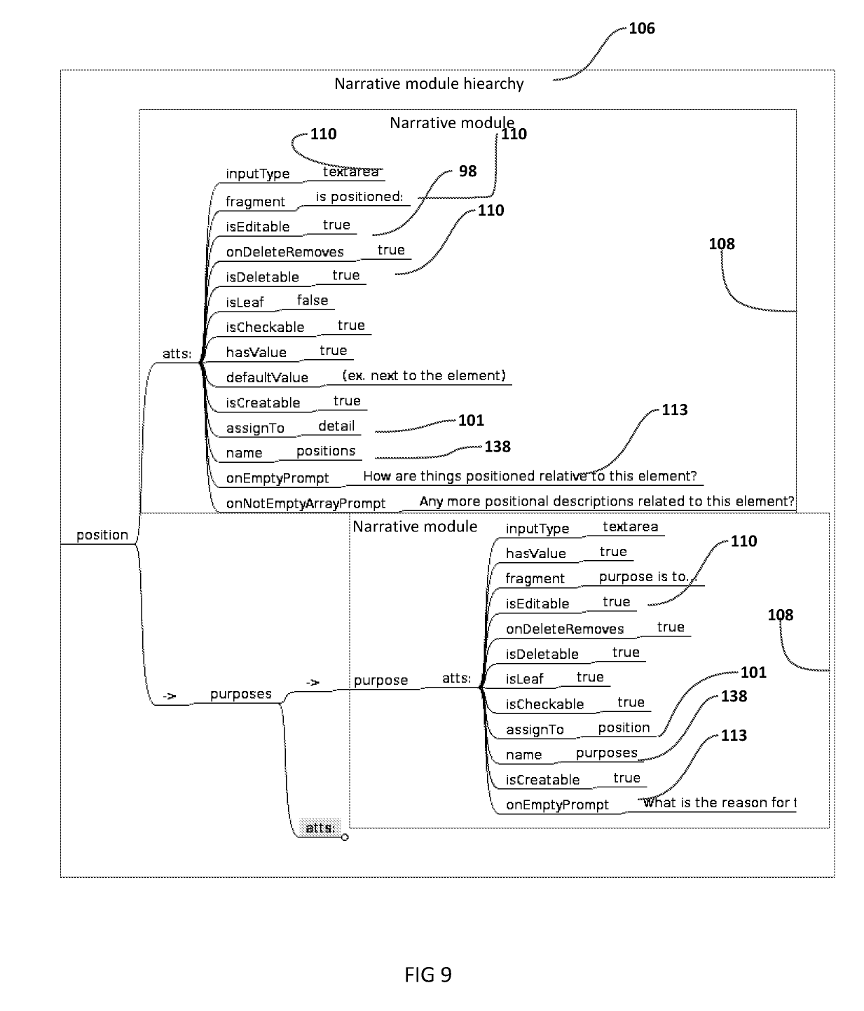

FIG. 10 is a graphical user interface view that shows two embodiments of a disclosure view which can accept information (top) a nominal xml editor configured to process the data (bottom) a more user friendly graphical view of the same.

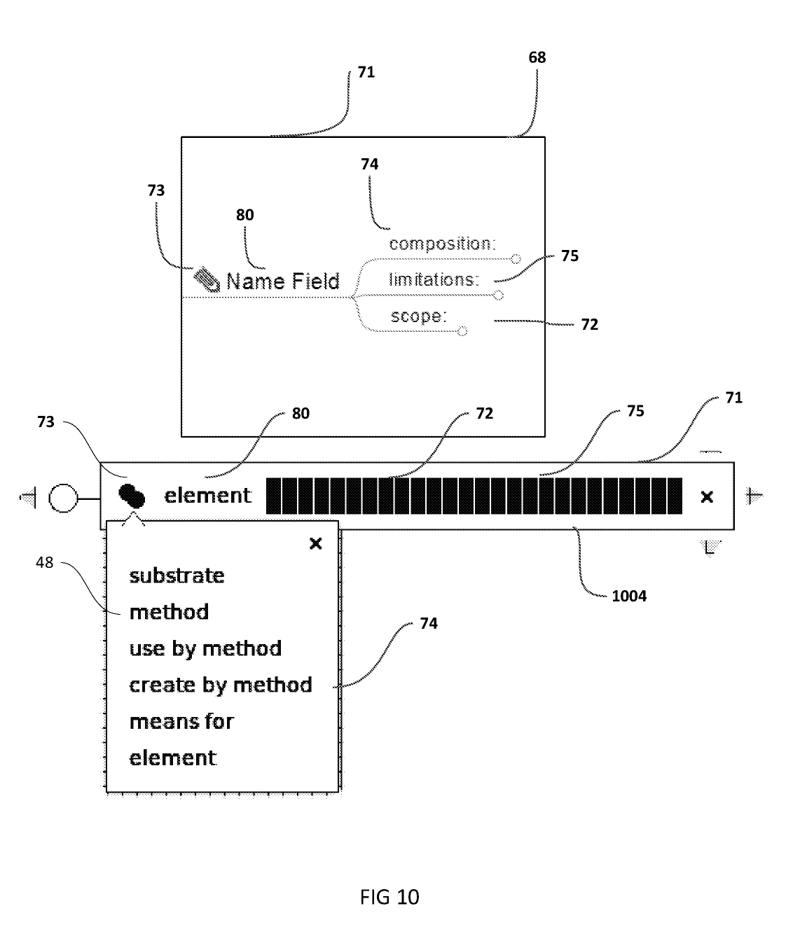

FIG. 11 is a graphical user interface view that shows a disclosure view with its sub limitation views within a nominal xml editor configured to process the data.

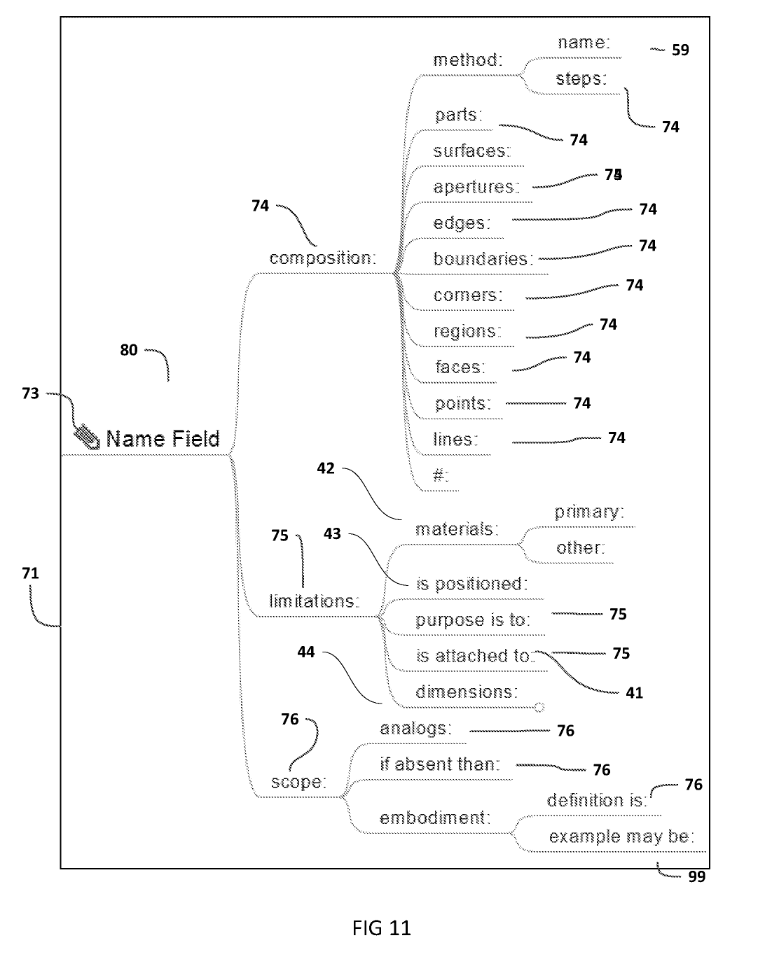

FIG. 12 is a graphical user interface view that shows a disclosure view with its sub limitation views within a more user friendly layout.

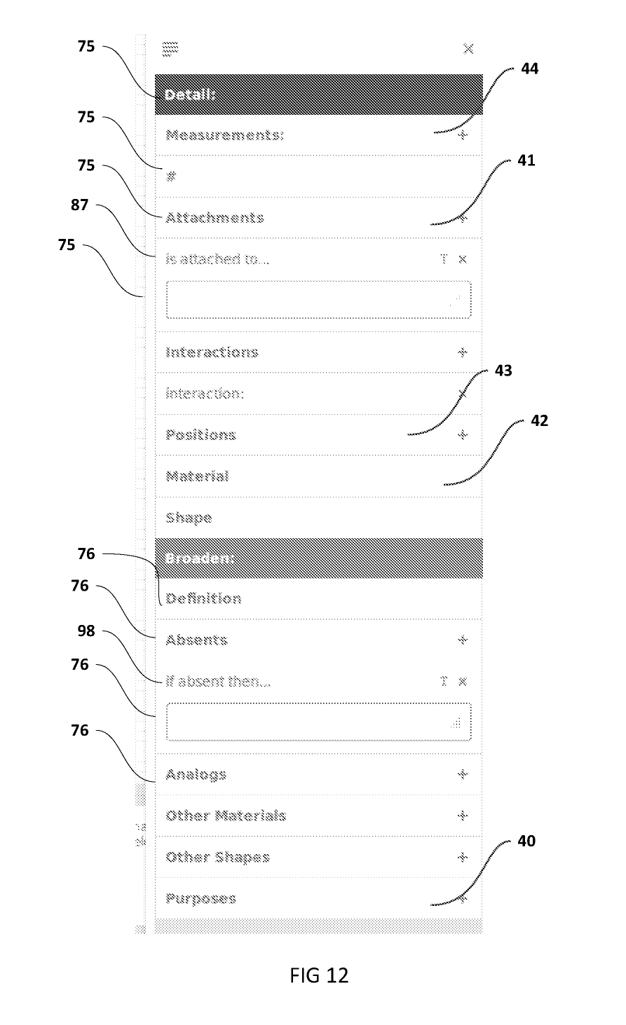

FIG. 13 is a graphical user interface view that shows several nested disclosure views that are methods and steps and their sublimitation views within a nominal xml editor configured to process the data.

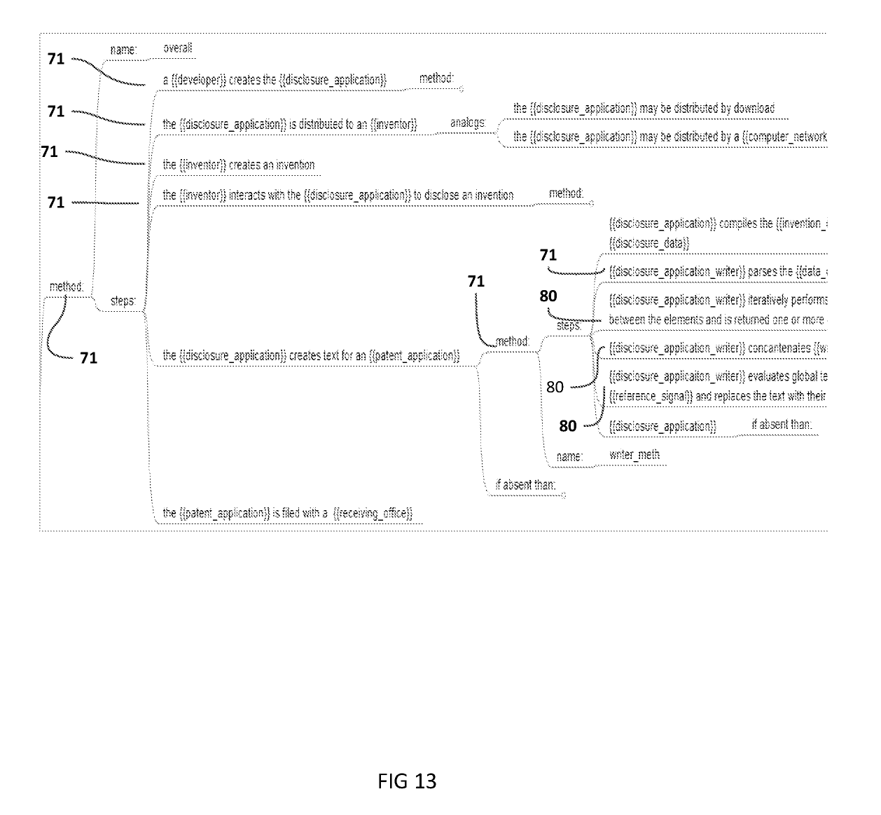

FIG. 14 is a graphical user interface view that shows several nested disclosure views that are methods and steps and their sublimitation views within a more user friendly interface (also showing related message prompt views).

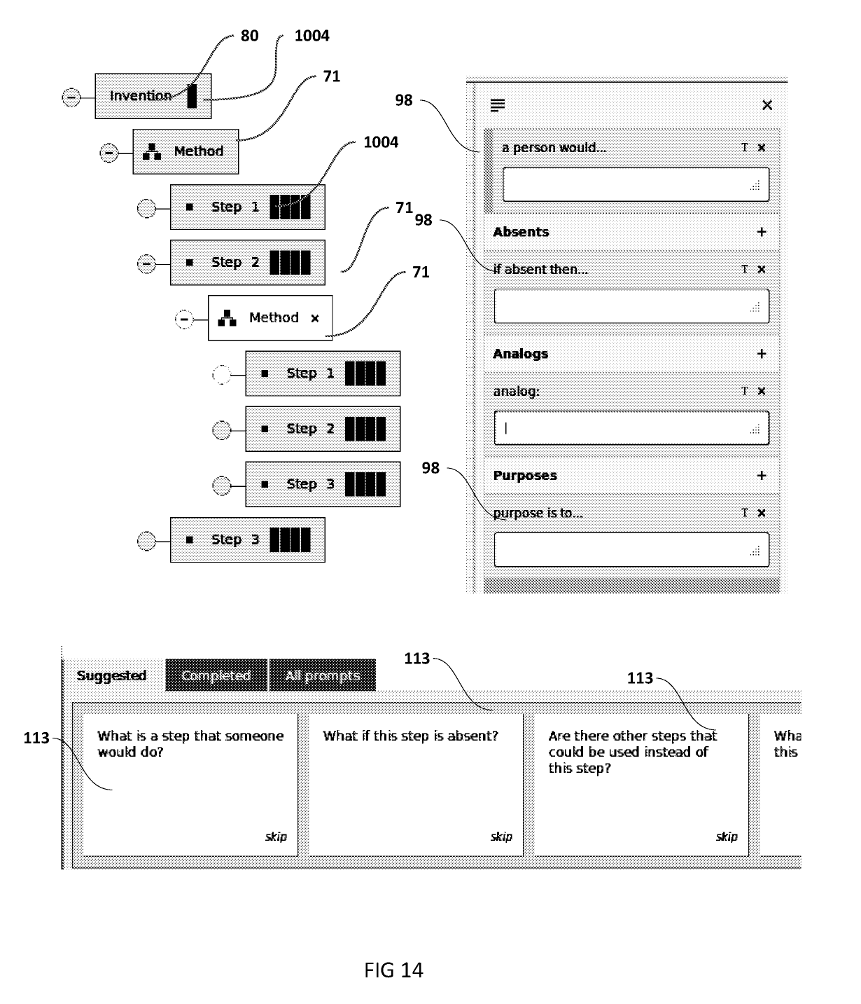

FIG. 15 is a graphical user interface view that shows example nested disclosure views and limitation and scope views within a nominal xml editor configured to process the data.

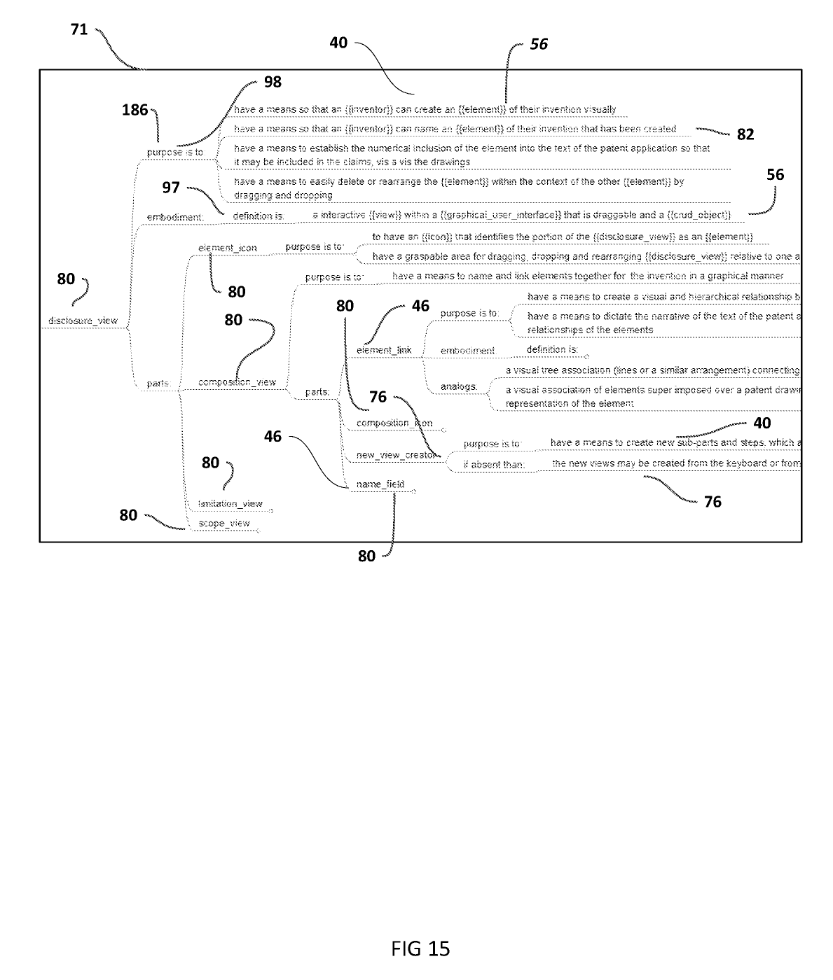

FIG. 16 is a graphical user interface view that shows example nested disclosure views and limitation check marks and prompt views within a user friendly interface.

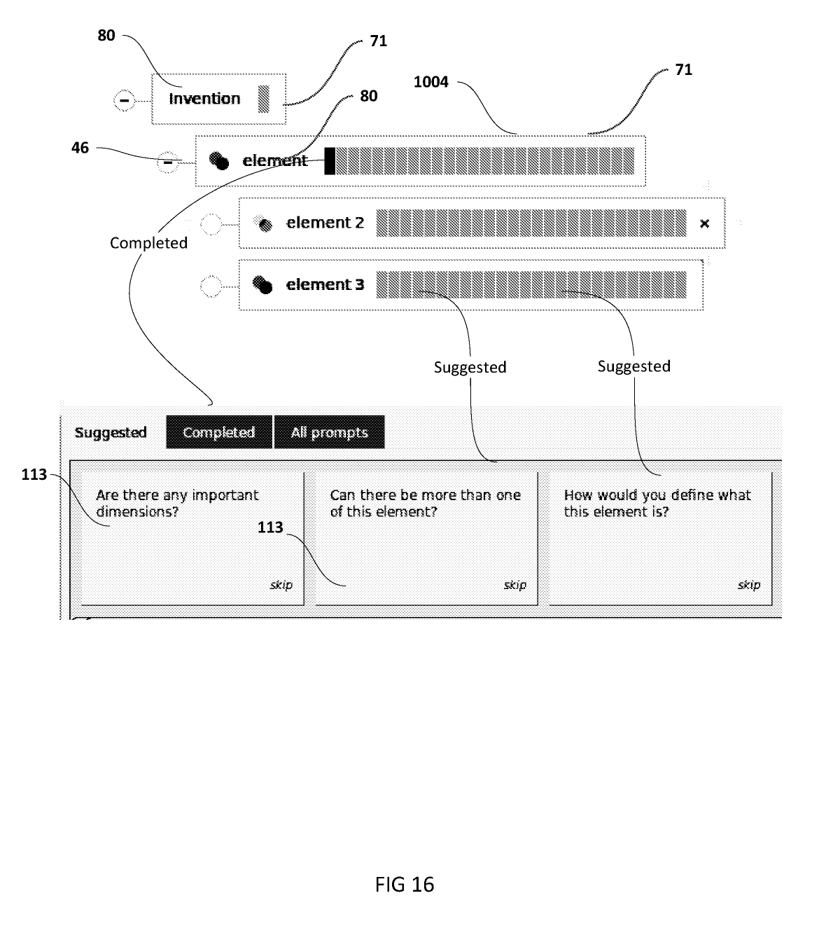

FIG. 17 is a diagrammed series of steps view that shows overall creation and use of the system.

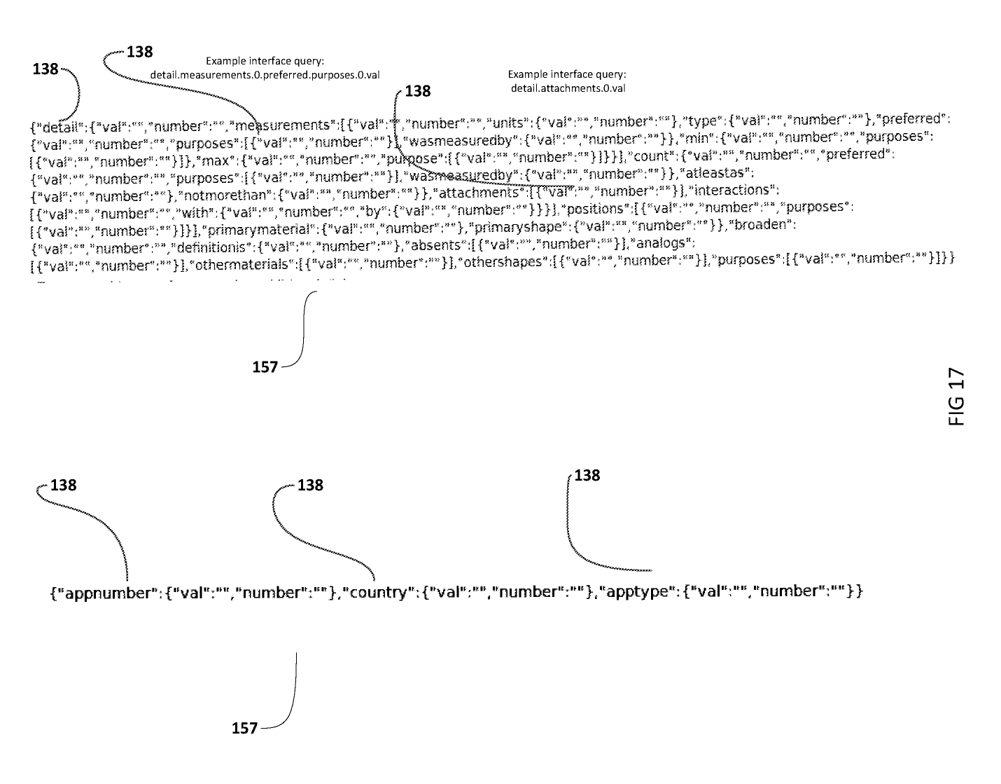

FIG. 18 is a diagrammed series of steps view that shows how a developer would create a disclosure application.

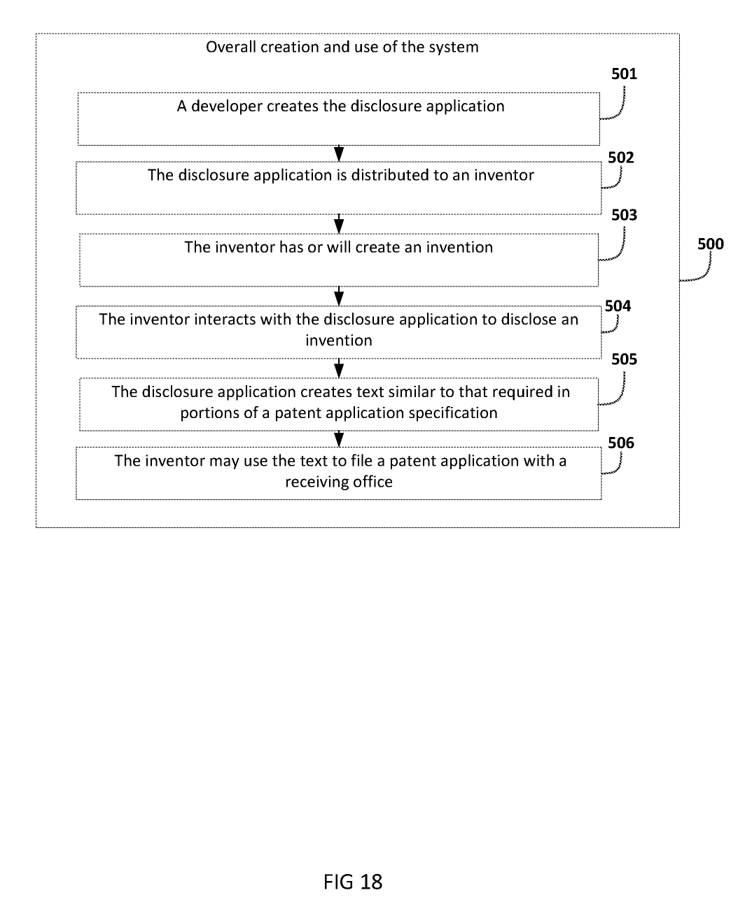

FIG. 19 is a diagrammed series of steps view that shows general steps and implementation and programming of the disclosure application.

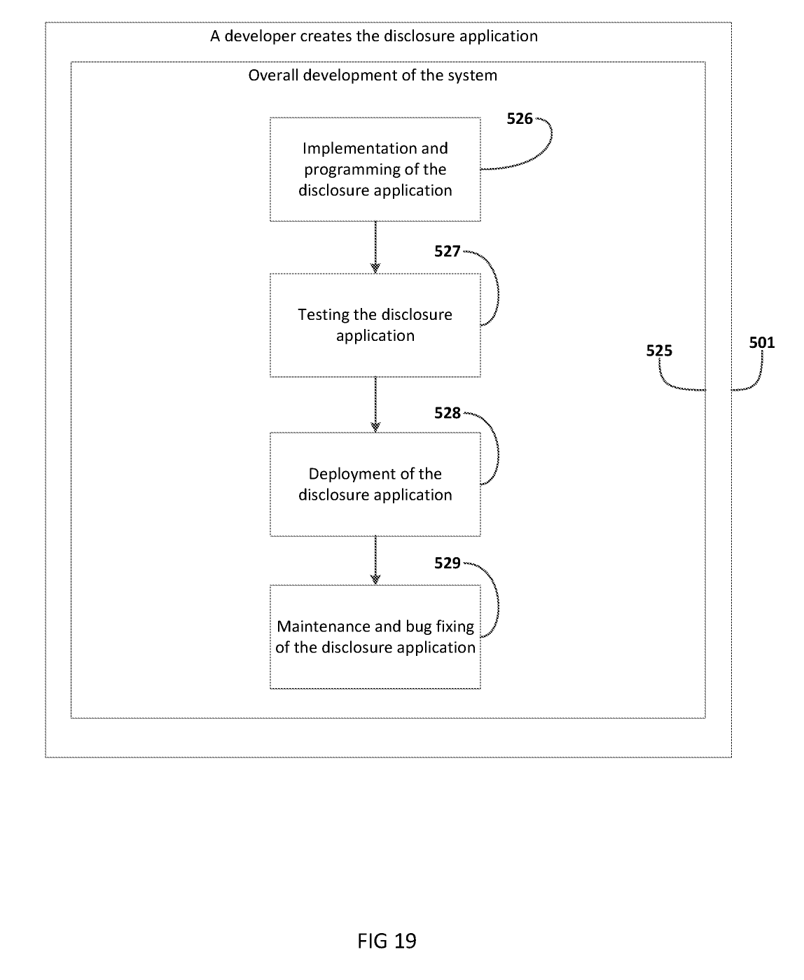

FIG. 20 is a diagrammed series of steps view that shows an embodiment where the interface on the presentation layer is created without an interface module.

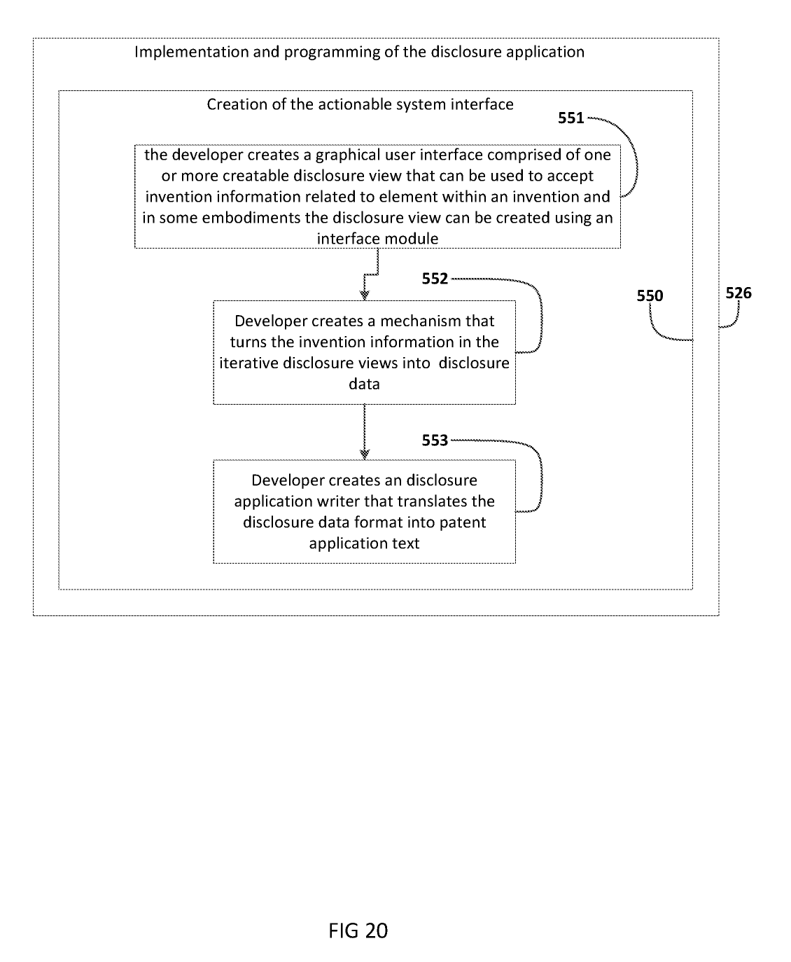

FIG. 21 is a diagrammed series of steps view that shows an embodiment where creating an interface is done through creating an interface module.

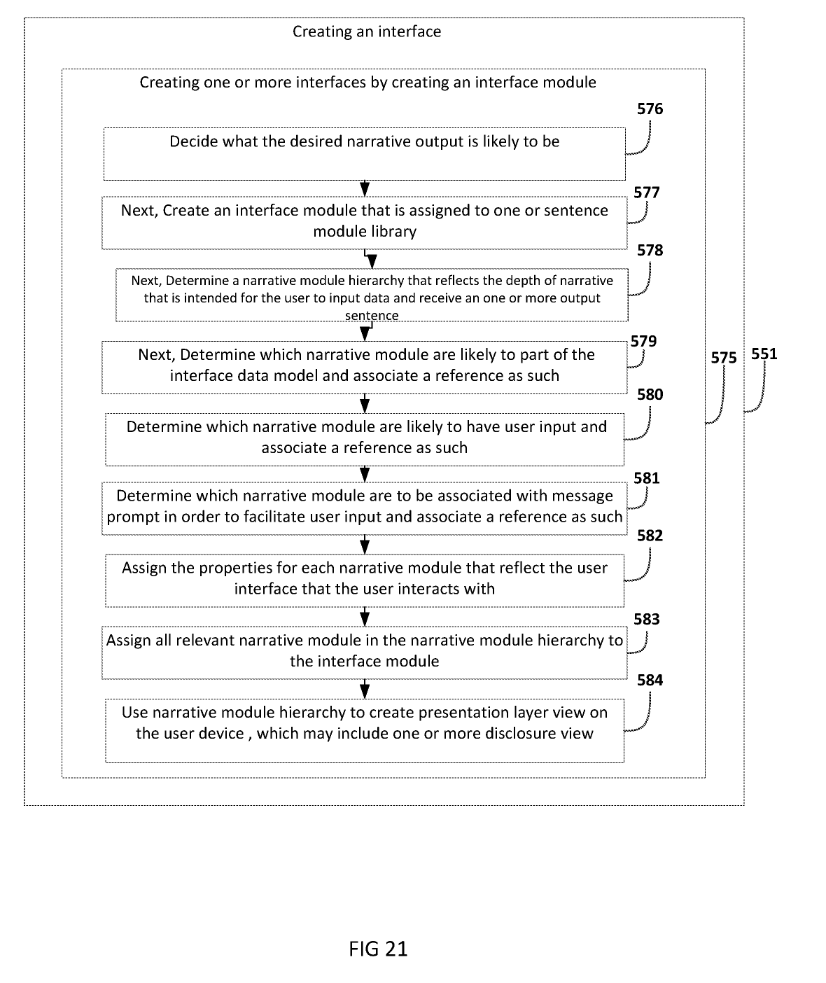

FIG. 22 is a diagrammed series of steps view that shows parsing an interface module with the disclosure application system to create interface in the presentation layer.

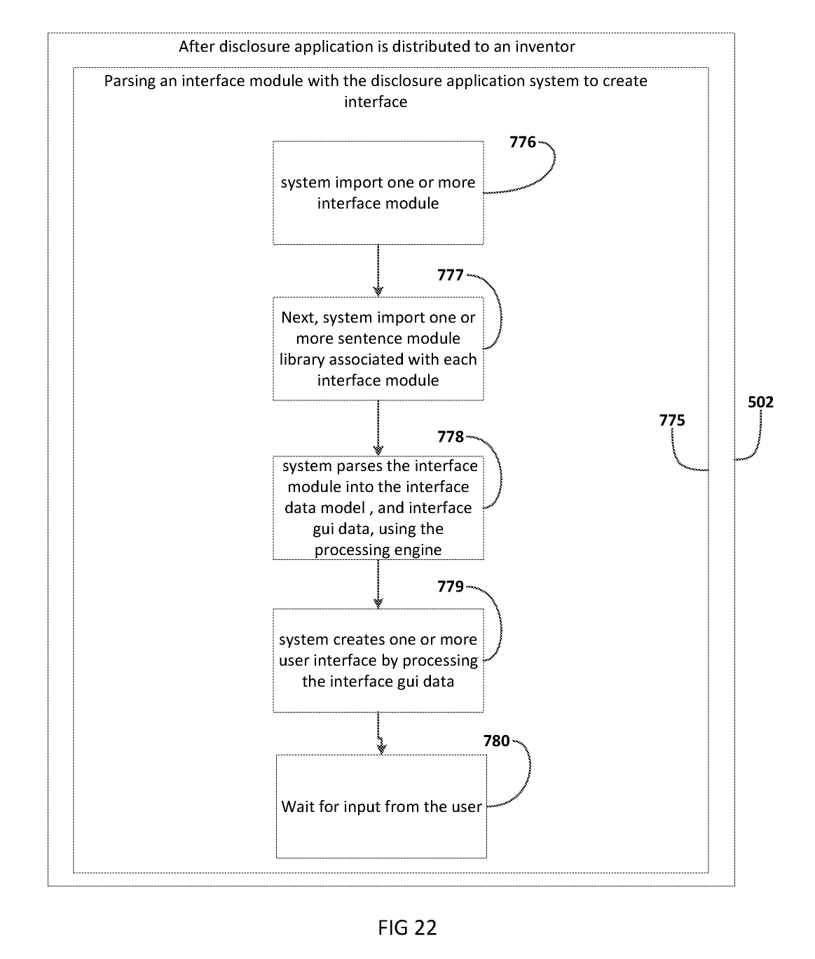

FIG. 23 is a diagrammed series of steps view that shows ways the disclosure application may be distributed.

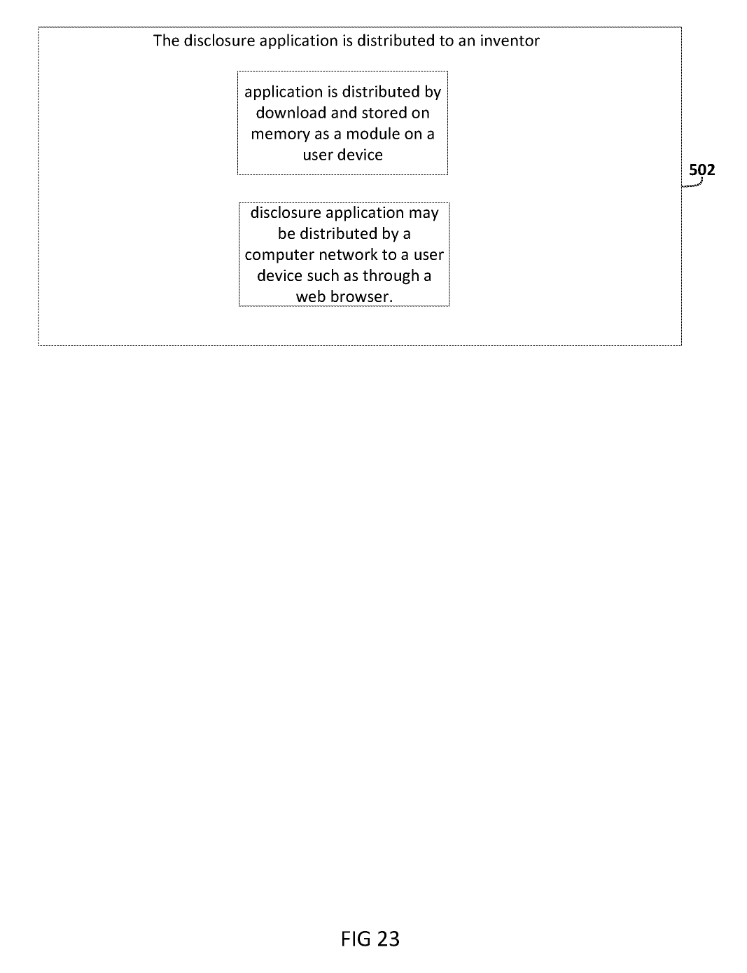

FIG. 24 is a diagrammed series of steps view that shows the steps to determine the composition narrative based on the relationship of the elements.

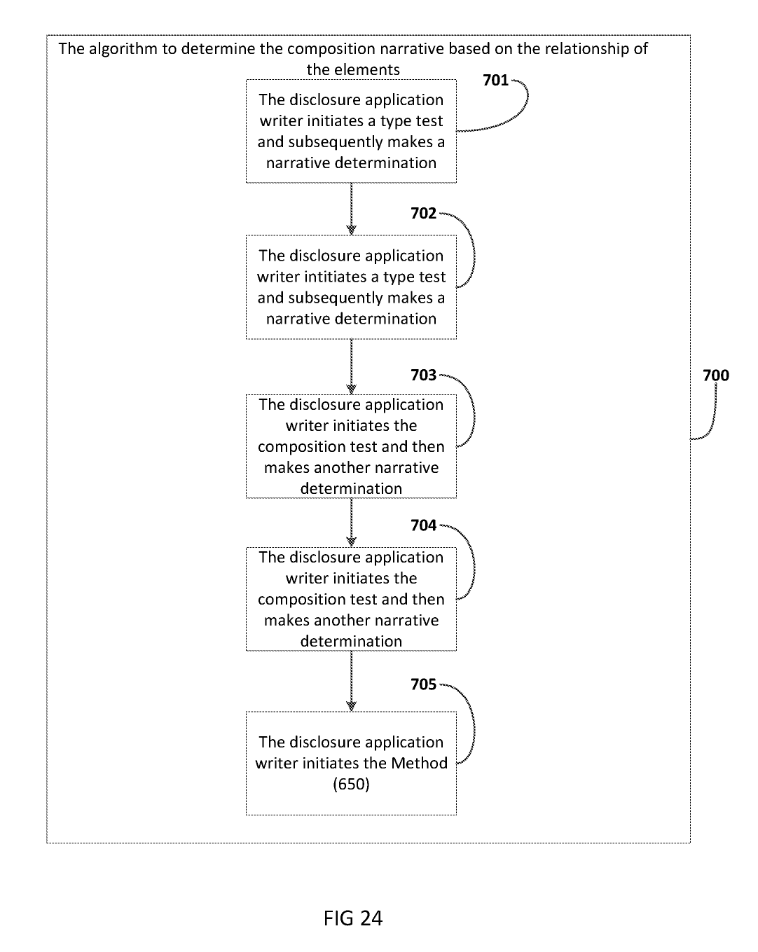

FIG. 25 is a diagrammed series of steps view that shows the steps to determine the limitation narrative based on the type and number of limitations (steps performed by an embodiment of disclosure application writer).

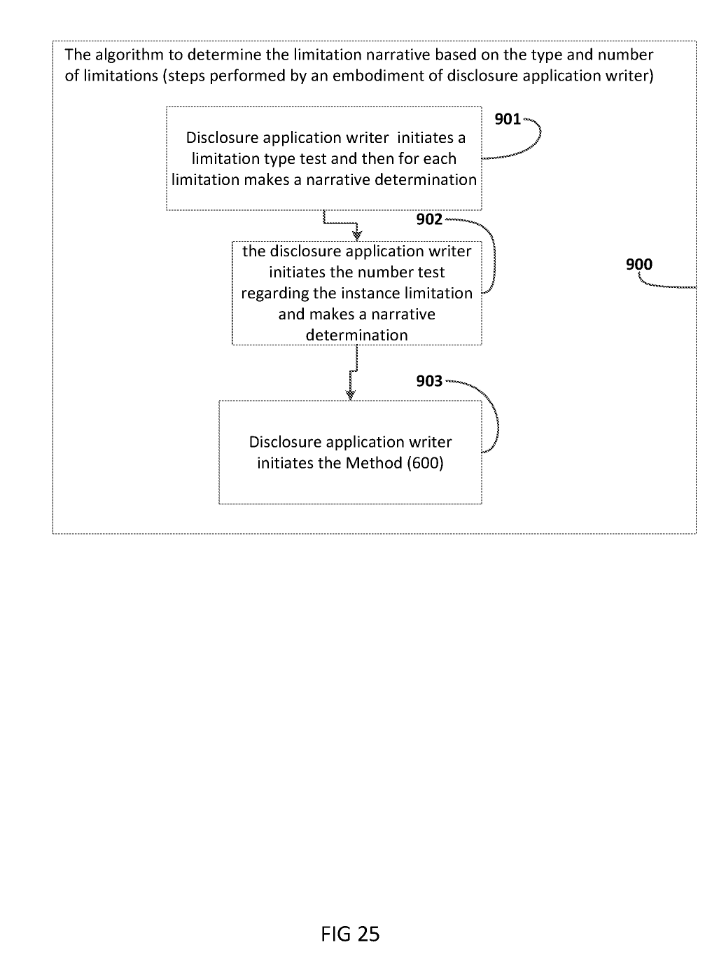

FIG. 26 is a diagrammed series of steps view that shows the steps to determine the scope narrative based on the type and number of limitations.

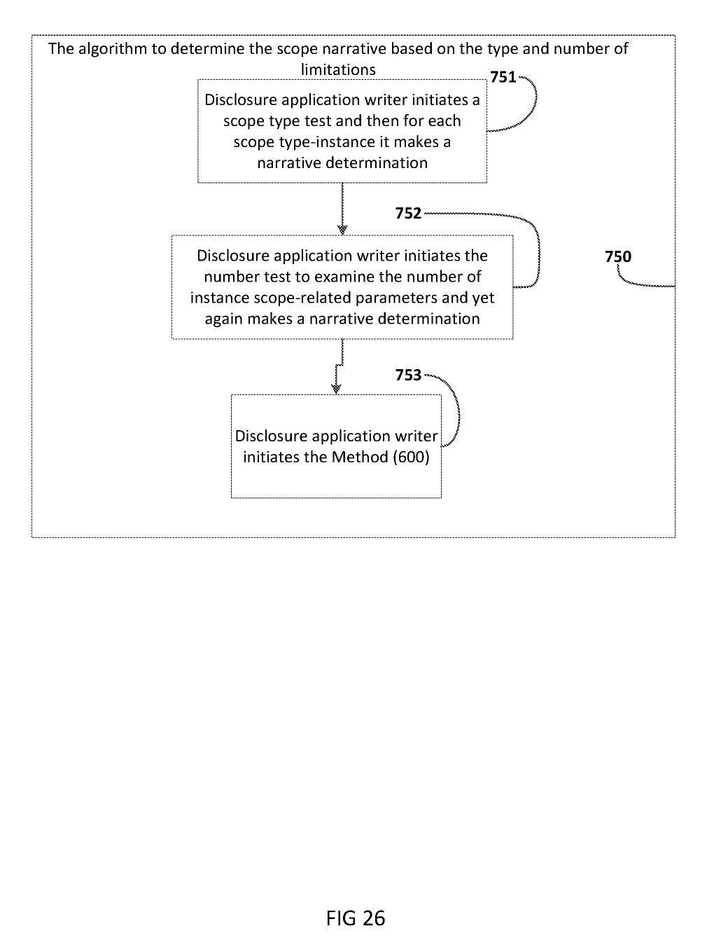

FIG. 27 is a diagrammed series of steps view that shows the process of the sentence constructor.

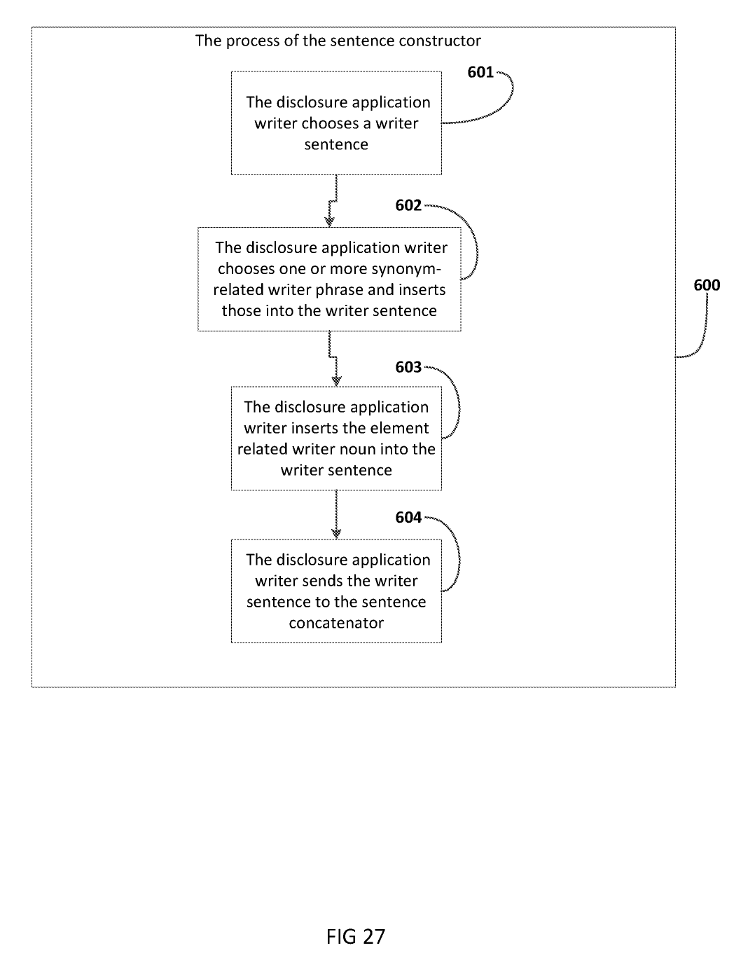

FIG. 28 is a diagrammed series of steps view that shows that in an alternative embodiment a sentence constructor can be created by creating a sentence module library.

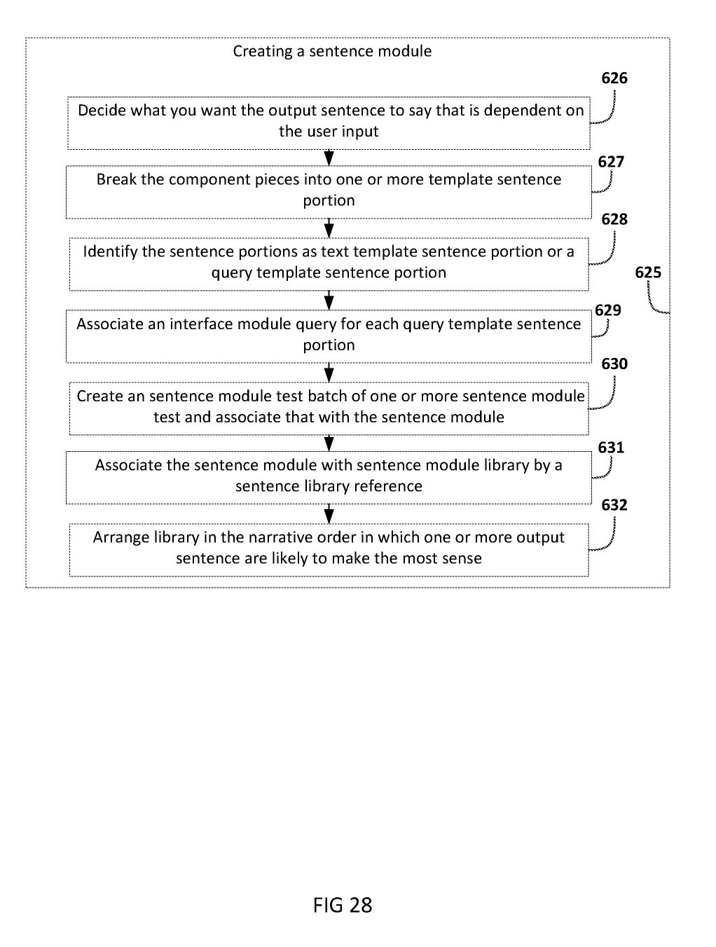

FIG. 29 is a diagrammed series of steps view that shows creating a sentence module.

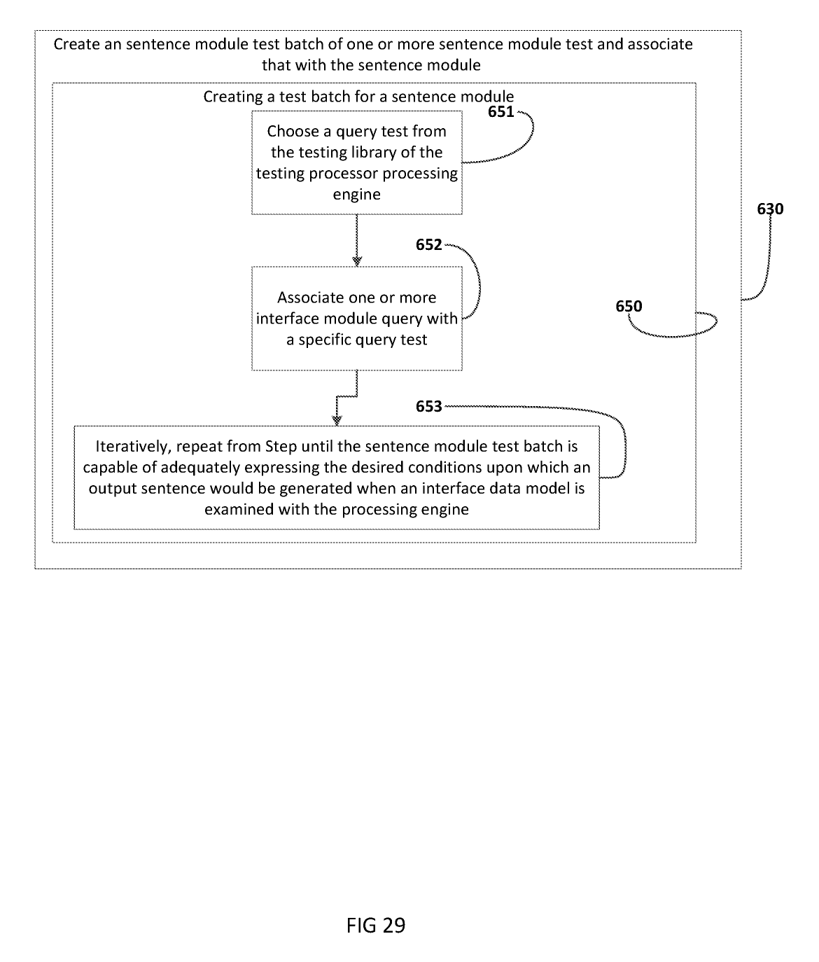

FIG. 30 is a diagrammed series of steps view that shows creating a sentence module test batch of one or more sentence module test and associate that with the sentence module.

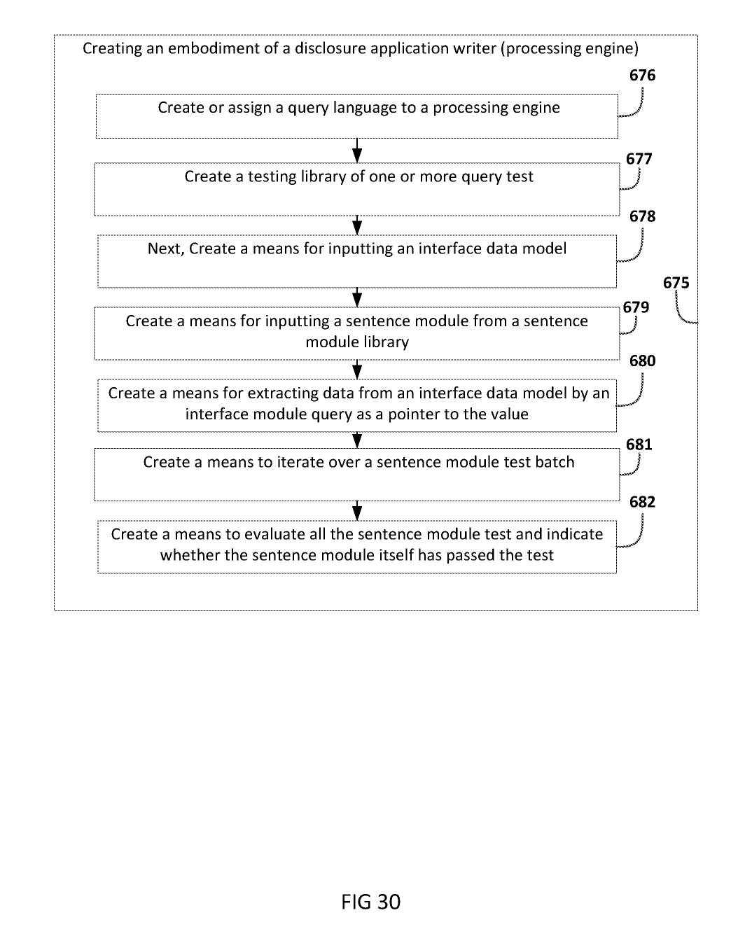

FIG. 31 is a diagrammed series of steps view that shows how the inventor interacts with the disclosure application to disclose an invention.

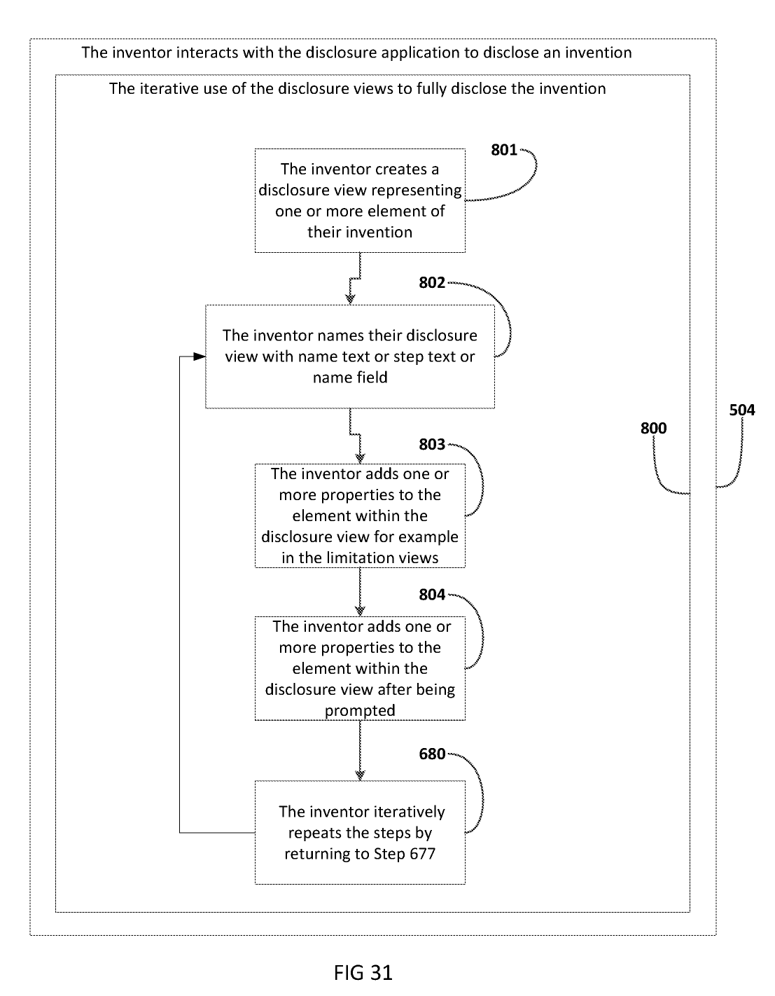

FIG. 32 is a diagrammed series of steps view that shows how the inventor adds one or more properties to the element within the disclosure view in order to disclose the invention completely.

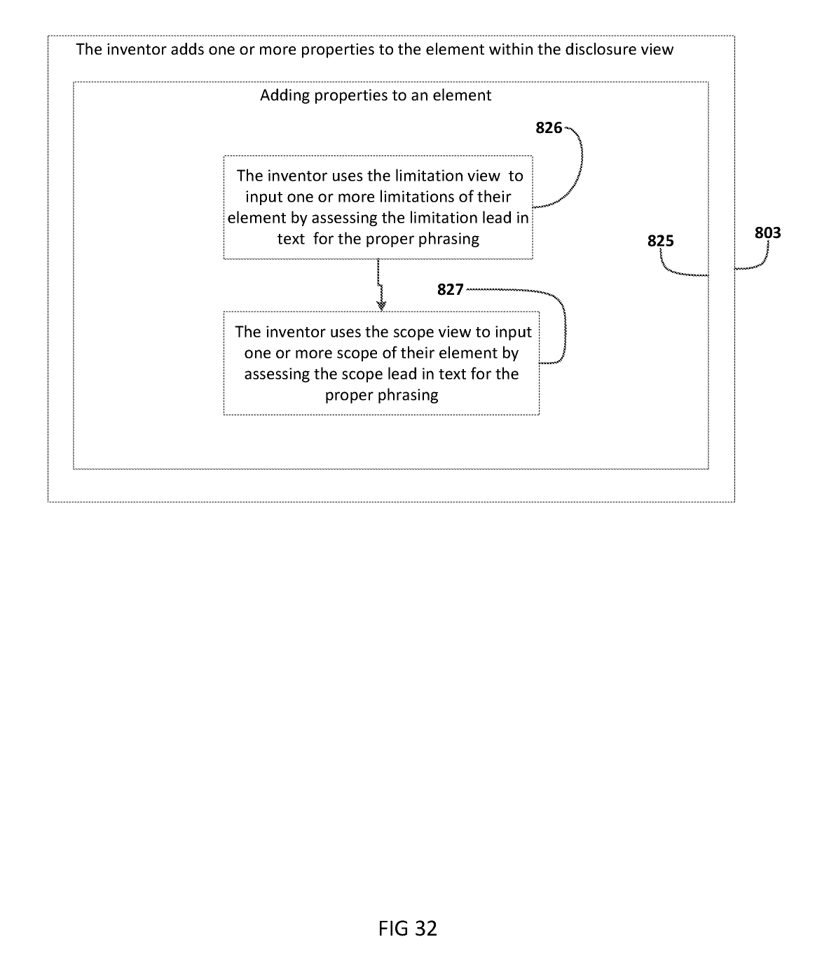

FIG. 33 is a diagrammed series of steps view that shows the general steps that the disclosure application use to create text similar to that required in portions of a patent application specification.

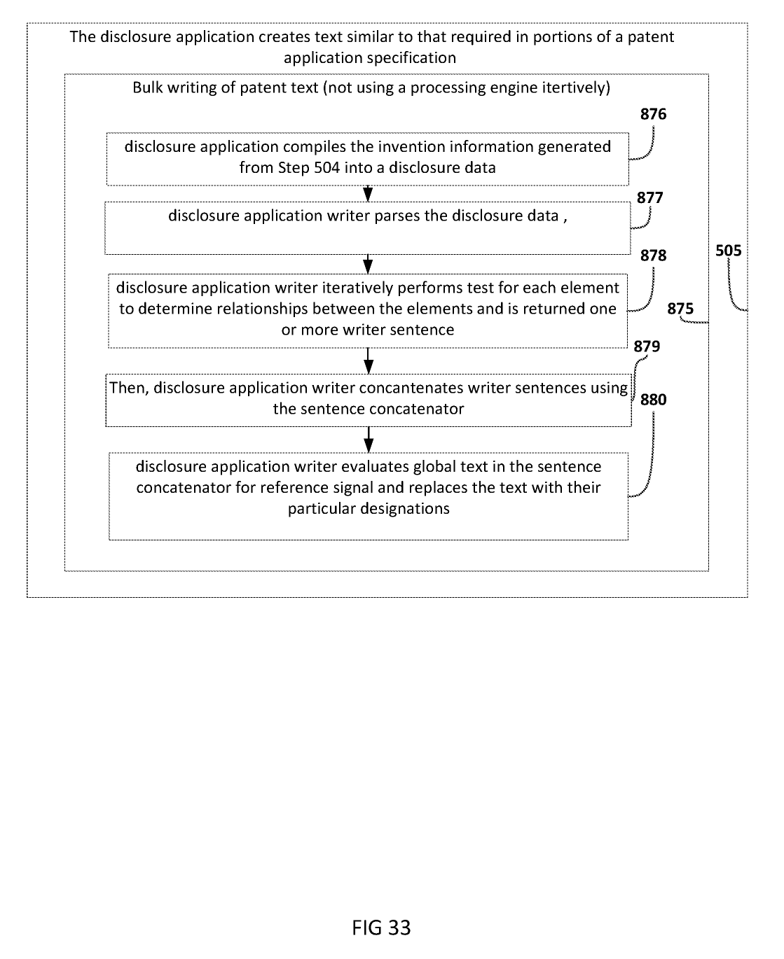

### DETAILED DESCRIPTION OF THE INVENTION

In general it is thought that this invention is a novel computer program which allows rapid disclosure of inventions. As it is a compute program, it is thought that a person may use one or more devices, such as user device and server, to aid in patent application preparation. It is though that the user device and server may be any type of general computing device, such as a mobile computing device, laptop, netbook, server, cell phone, smart phone, personal digital assistant, tablet computer, or any other device capable of executing one or more instructions. The user device and server may contain one or more processors, such as processors which may be a central processing unit, a microprocessor, a general purpose processor, an application specific processor, or any device that executes instructions. The user device and server may also include one or more memories, that store data one or more software modules. The memory may be implemented using any computer-readable storage medium, such as hard drives, CDs, DVDs, flash memory, RAM, ROM, etc. The memory may store a module, or application, or interface, library or engine which may be executed by processor. The user interface may include one or more of a screen, a display, a projector, a touch panel, a pointing device, a scrolling device, a button, a switch, a motion sensor, an audio sensor, a pressure sensor, a thermal sensor, etc. The user interface may allow one or more inter faces to present information to a user, such as a plan or intervention. The user interface may be web based, such as a web page, or a stand-alone application. The user interface may also be configured to accept information about a user, such as user feedback. The user may manually enter the information, or it may be entered automatically. The system may also include one or more data bases, such as database on a device or server. Database 102 may be implemented using any database technology known to one of ordinary skill in the art, such as relational database technology or object-oriented database technology.

In general, this invention has several steps for using it, a number of sub-steps and definitions (detailed below). Overall the steps of using the invention are as follows: a developer 14 creates the disclosure application 1 (herein termed the Method (1)—Step(1) 501 Next, the disclosure application 1 is distributed to an inventor 3, (herein termed the Method (1)—Step(2) 502). Then, the inventor 3 creates an invention, (herein termed the Method (1)—Step(3) 503). Then, the inventor 3 interacts with the disclosure application 1 to disclose an invention, (herein termed the Method (1)—Step(4) 504). Then, the disclosure application 1 creates text for an patent application 4, (herein termed the Method (1)—Step(5) 505). Finally, the patent application 4 is filed with a receiving office 61, (herein termed the Method (1)—Step(6) 506). Some embodiments of this invention may employ the analogous step of the disclosure application 1 being distributed by download, herein termed as method (1)—step(7) 507, or perhaps the analogous step of the disclosure application 1 being distributed by a computer network 12, herein termed as method (1)—step(8) 508 instead of Step 502. The aforementioned method is herein termed Method (1) 500. While the steps in Method (1) 500 are depicted in a particular order, the principles of the present disclosure are not limited to the order depicted immediately above. Additionally, embodiments of the Method (1) 500 process can include more or less steps than those depicted.

In addition, the Step 501 has several sub steps for using it which are as follows: there is implementation and creation of a program 20 of the disclosure application 1 (herein termed the Method (2)—Step(1) 526 Next, there is testing the disclosure application 1, (herein termed the Method (2)—Step(2) 527). Next, there is deployment of the disclosure application 1, (herein termed the Method (2)—Step(3) 528). Finally, there is maintenance and bug fixing of the disclosure application 1, (herein termed the Method (2)—Step(4) 529). The aforementioned method is herein termed Method (2) 525. While the steps in Method (2) 525 are depicted in a particular order, the principles of the present disclosure are not limited to the order depicted immediately above. Additionally, embodiments of the Method (2) 525 process can include more or less steps than those depicted.

The Step 526 has several sub steps for using it which are as follows: First, the developer 14 creates a graphical user interface 231 comprised of one or more creatable disclosure view 71 that can be used to accept invention information 62 related to element 46 within an invention and in some embodiments the disclosure view 71 can be created using an interface module 72 (herein termed the Method (3)—Step(1) 551). Then, the developer 14 creates a mechanism that turns the invention information 62 in the iterative disclosure views 63 into a disclosure data 13, (herein termed the Method (3)—Step(2) 552). Finally, the developer 14 creates an disclosure application writer 150 that translates the disclosure data format 39 into patent application 4 text, (herein termed the Method (3)—Step(3) 553). The aforementioned method is herein termed Method (3) 550. In some versions of the invention, it is thought that if Step 552 is absent than the invention information 62 may not be compiled in totality, but may be iteratively sent piece by piece to the disclosure application writer 150. While the steps in Method (3) 550 are depicted in a particular order, the principles of the present disclosure are not limited to the order depicted immediately above. Additionally, embodiments of the Method (3) 550 process can include more or less steps than those depicted.

The Step 551 creates a disclosure view 71 and may use an interface module 72 to create the view in some embodiments. The term disclosure view 71 is thought to encompass a interactive view 35 within a graphical user interface 231 that is draggable and a crud object 60. The term interface module 72 is broadly thought to include a data module that comprises one or more narrative module 108.

There are many objectives, that the disclosure view 71 is designed to perform. First, the disclosure view 71 functions to have a means so that an inventor 3 can create an element 46 of their invention visually. Also, the disclosure view 71 is designed to have a means so that an inventor 3 can name an element 46 of their invention that has been created. Additionally, the disclosure view 71 functions to have a means to establish the numerical inclusion of the element into the text of the patent application so that it may be included in the claims, vis a vis the drawings. Additionally, the disclosure view 71 intends to have a means to easily delete or rearrange the element 46 within the context of the other element 46 by dragging and dropping. In some embodiments a disclosure view can be coded as a user interface, processed from an xml editor or generated by an interface module.

The disclosure view 71 preferably comprises 4 pieces, defined as the element icon 73, the composition view 74, the limitation view 75, and the scope view 76. Some aims of the element icon 73 are to both 1) to have an icon 38 that identifies the portion of the disclosure view 71 as an element 46 and 2) have a graspable area for dragging, dropping and rearranging disclosure view 71 relative to one another. The composition view 74 functions to have a means to name and link elements together for the invention in a graphical manner. The composition view 74 comprises 4 accompanying parts; the element link 77, the composition icon 78, the new view creator 79, and the name field 80. The element link 77 is intended to both 1) have a means to create a visual and hierarchical relationship between element 46 of the invention and also to 2) have a means to dictate the narrative of the text of the patent application by establishing the hierarchical relationships of the elements.

One objective of the composition icon 78 is to have an icon 38 that identifies a region used to create a new sub-instance of a disclosure view 71 that is hierarchically related to the immediate instance of the disclosure view 71. One intention of the new view creator 79 is to have a means to create new sub-parts and steps, which are themselves a disclosure view 71. If the new view creator 79 is not required, it is reasonable to contemplate that the new views may be created from the keyboard or from another user action.

The name field 80 is preferably comprised of either the name text 83 and the step text 84 and has many purposes, which are as follows: First, the name field 80 aims to have an inputting means to establish the name of the element if it is a part 58, or the procedure if it is an step 59. Also, the name field 80 functions to establish an element reference 53 so that other element 46 may refer to it in their limitation field 86. Additionally, the name field 80 intends to have a means to have the text of a step 59 for use of the invention. Further, the name field 80 functions to establish a element reference 53, which, if the element is step or part, can be referred to by a shorthand reference 54. The name field 80 is comprised of two parts, the name text 83 and the step text 84.

If the name field has name text then some aims of the name text 83 are to both 1) have a name for the disclosure view 71 that can be used in the patent application text and 2) have a name for the disclosure view 71 that can be referred to by being wrapped in an reference signal 56. it is reasonable to contemplate that if the name text 83 is absent in some instances than the text of the process of a step (an step text 84 may be used. If the name field has step text then the step text 84 functions to both 1) have the text of a step for the disclosure view 71 that can be used in the patent application text and also to 2) automatic creation of a shorthand reference 54 that can be referred to by being wrapped in an reference signal 56. It is thought that the name text and step text are two examples of many possibilities of denoting text from a disclosure view which may also be method designation, means for designation, or any general text that serves as a marker for a hierarchical relationship.

Under the disclosure view is one or more limitation view. The term limitation view 75 is broadly thought to include a means to allow the inventor to graphically denote one or more limitation 50 for a particular element 46. One objective of the limitation view 75 is to have a means to describe the element 46 in the disclosure view 71 and in general limitation view 75 preferably comprises 3 items; the element limitation icon 85, the limitation field 86, and the limitation lead in text 87. The element limitation icon 85 aims to have an icon 38 that identifies a particular type of limitation field 86 in a disclosure view 71. The purpose of the limitation field 86 is to have a means to add a value to a type of limitation 50. Further, the limitation lead in text 87 is to have a means to characterize the type of sentence that will be written from the text entered into the limitation field 86. Alternatively, in other embodiments of the invention the limitation lead in text 87 may be a purpose is to ______ 90, a is attached to ______ 91, a dimension is ______ 92, a dimension range is ______ 93, a an example is ______ 94, a dimension is not more than ______ 95, or a dimension is not less than ______ 96.

In contrast to the limitation view, the scope view is primarily to highlight alternate embodiments relevant to the element. As such the intention of the scope view 76 is to have a means to show the scope of the functionality of the element, by contemplating replacements, its absence and general definition. The scope view 76 preferably comprises 3 sub-components; the scope icon 97, the scope lead in text 98, and the scope field 99. Similar to the limitation view one objective of the scope icon 97 is to have an icon 38 that identifies a region used to define the scope and embodiment-related parameters of the immediate instance of the disclosure view 71. Also similar to the limitation view, one intention of the scope lead in text 98 is to have a means to characterize the type of sentence that will be written from the text entered into the scope field 99. For example, some embodiments may use a if absent than ______ 100, a definition is ______ 101, a an analog is ______ 102, or a an example would be ______ 103 as the scope lead in text 98. Finally, The scope field 99 functions to have a means to clarify the interpretation or scope of a particular element in multiple embodiments.

In order to create one or more disclosure views by creating an interface module one would perform as follows: First, Decide what the desired narrative output 127 is likely to be (herein termed the Method (4)—Step(1) 576). Next, Create an interface module 72 that is assigned to one or sentence module library 130, (herein termed the Method (4)—Step(2) 577). Next, Determine a narrative module hierarchy 106 that reflects the depth of narrative that is intended for the user to input data and receive an one or more output sentence 151, (herein termed the Method (4)—Step(3) 578). Next, Determine which narrative module 108 are likely to part of the interface data model 157 and associate a reference as such, (herein termed the Method (4)—Step(4) 579). Then, Determine which narrative module 108 are likely to have user input 64 and associate a reference as such, (herein termed the Method (4)—Step(5) 580). Then, Determine which narrative module 108 are to be associated with message prompt 113 in order to facilitate user input 64 and associate a reference as such, (herein termed the Method (4)—Step(6) 581). Next, Assign the properties for each narrative module 108 that reflect the user interface 65 that the user interacts with, (herein termed the Method (4)—Step(7) 582). Next, Assign all relevant narrative module 108 in the narrative module hierarchy 106 to the interface module 72, (herein termed the Method (4)—Step(8) 583). Last, Use narrative module hierarchy 106 to create presentation layer 6 view on the user device 66, which may include one or more disclosure view 71, (herein termed the Method (4)—Step(9) 584). The aforementioned method is herein termed Method (4) 575. While the steps in Method (4) 575 are depicted in a particular order, the principles of the present disclosure are not limited to the order depicted immediately above. Additionally, embodiments of the Method (4) 575 process can include more or less steps than those depicted.

The interface module 72 preferably comprises two components, the narrative module hierarchy 106 and the interface module tree representation 107 and further, the narrative module hierarchy 106 has one or more narrative module 108. The term narrative module hierarchy 106 is broadly thought to include the specific arrangement of narrative module 108 relative to one another that determines the order of message prompt 113 and the order of terms in an interface module query 147. The term interface module tree representation 107 is broadly thought to include a data representation of the interface module 72 and narrative module hierarchy 106 that can be queried with a query language 153 by the processing engine 152. Alternatively, in other embodiments of the invention the interface module tree representation 107 may be a xml 124, a html 125, or a json 126

The narrative module is a specific narrative junction. For example, if one wants to talk about the position of an element, a subsequent narrative module (child module) may want to know the purpose of that positioning, and yet a subsequent narrative module may be prompt an example of how that purpose of that position is more clear. It is a flexible way to create narrative paths and branch points for prompting necessary for extracting information from a user.

The narrative module 108 preferably comprises 5 accompanying sub-elements; the array reference 109, the display properties 110, the model reference 111, the interface module query term reference 112, and the message prompt 113. The term array reference 109 is broadly thought to include means for designating the name of the narrative module 108 so that it can be referenced by an interface module query 147. The term display properties 110 is broadly thought to include means for determining the properties of the limitation view 75 when built in the presentation layer 6. The term model reference 111 may include means for designating the narrative module 108 as part of the interface data model 157. The term interface module query term reference 112 is thought to encompass means for designating the name of the narrative module 108 so that it can be referenced by an interface module query 147. The term message prompt 113 may include a portion of the presentation layer 6 associated with a narrative module 108 which prompts the user for information which would lead to input used to create the text of the patent application.

Thus the interface module and sub narrative modules can create the views and interfaces rapidly needed to prompt and handle user input. Next is a mechanism to translate the user input into sentences. The Step 552 (the developer 14 creates a mechanism that turns the invention information 62 in the iterative disclosure views 63 into a disclosure data) requires system elements including narrative output 127, a sentence constructor 128, a sentence concatenator 129, and in some embodiments a sentence module library 130. The term narrative output 127 may include the narrative constructed from one or more sentences. The term sentence concatenator 129 is thought to encompass a holder for many writer sentence 131 that concatenates the writer sentence 131 into the text of the patent application 4. The term sentence constructor is a means to create a bunch of sentences, which may be one or more sentence modules in a sentence module library, which would then be processed by the sentence concatenator or in alternative embodiments the processing engine. The sentence constructor 128 preferably uses 4 accompanying pieces; the writer sentence 131, the writer phrase 132, the writer noun 133, and in broader terms a simple template sentence portion 134, characterized in a sentence module.

The sentence constructor 128 would have several sub steps for using it to build sentences as follows: the disclosure application writer 150 chooses a writer sentence 131 (herein termed the Method (5)—Step(1) 601 Next, the disclosure application writer 150 chooses one or more synonym-related writer phrase 132 and inserts those into the writer sentence 131, (herein termed the Method (5)—Step(2) 602). Then, the disclosure application writer 150 inserts the element 46 related writer noun 133 into the writer sentence 131, (herein termed the Method (5)—Step(3) 603). Finally, the disclosure application writer 150 sends the writer sentence 131 to the sentence concatenator 129, (herein termed the Method (5)—Step(4) 604). The aforementioned method is herein termed Method (5) 600. While the steps in Method (5) 600 are depicted in a particular order, the principles of the present disclosure are not limited to the order depicted immediately above. Additionally, embodiments of the Method (5) 600 process can include more or less steps than those depicted.

Alternatively, a sentence module library 130 can be created with similar sub steps as follows: Decide what you want the output sentence 151 to say that is dependent on the user input 64 (herein termed the Method (6)—Step(1) 626 Next, Break the component pieces into one or more template sentence portion 140, (herein termed the Method (6)—Step(2) 627). Then, Identify the sentence portions as text template sentence portion 145 or a query template sentence portion 146, (herein termed the Method (6)—Step(3) 628). Then, Associate an interface module query 147 for each query template sentence portion 146, (herein termed the Method (6)—Step(4) 629). Then, create an sentence module test batch 142 of one or more sentence module test 149 and associate that with the sentence module 139, (herein termed the Method (6)—Step(5) 630). Next, Associate the sentence module 139 with sentence module library 130 by a sentence library reference 141, (herein termed the Method (6)—Step(6) 631). Then, Iteratively, repeat from Step 626 until the sentence module library 130 is capable of expressing a narrative, (herein termed the Method (6)—Step(7) 632). Finally, Arrange library in the narrative order in which one or more output sentence 151 are likely to make the most sense, (herein termed the Method (6)—Step(8) 633). The aforementioned method is herein termed Method (6) 625. While the steps in Method (6) 625 are depicted in a particular order, the principles of the present disclosure are not limited to the order depicted immediately above. Additionally, embodiments of the Method (6) 625 process can include more or less steps than those depicted.

The term sentence module library 130 may include a module 8 that exists in a database 15 on a server 18 or user device 66 which has one or more sentence module 139 and is associated with one or more interface module 72. It is a convenient way to arrange like sentences within a single interface. One of its members, the sentence module 139 preferably 5 components, respectively defined as the template sentence portion 140, the sentence library reference 141, the sentence module test batch 142, the sentence module passing state reference 143, and the sentence module failing state reference 144.

The term template sentence portion 140 is thought to encompass one or more portions of sentence module 139 that create an output sentence 151. It is a fragment of text that may be a standard text, or alternatively, a query on an interface data model. The template sentence portion 140 preferably two items, the text template sentence portion 145 and the query template sentence portion 146. The term text template sentence portion 145 may include portion of a sentence module 139 that contains text that effects the meaning of the output sentence 151. The term query template sentence portion 146 may include portion of a sentence module 139 that necessarily links to a interface module 72 or narrative module 108 by a query language 153. It is a means to interact with the narrative module hierarchy narrative decision points.

Additionally, the query template sentence portion 136 has a interface module query 137 and the term interface module query 147 is thought to encompass a string containing one or more interface module query term reference 112 linked by the syntax of the query language 153, wherein said querying the absence of user input or properties of user input, that is specific to the structure of the interface module 72 and the narrative module 108 nested within, and is composed of within query language 153. The interface module query 147 preferably comprises the interface module query term 148. The term interface module query term 148 may include a string that refers to one narrative module 108 by a property designated by the narrative module 108.

The term sentence library reference 141 is thought to encompass a property of the sentence module 139 that allows it to be referenced as a singular entity. The term sentence module passing state reference 143 is broadly thought to include a reference that an output sentence 151 should be produced. The term sentence module failing state reference 144 is broadly thought to include a reference that an output sentence 151 should not be produced.

The test batch of a sentence module is a test of the state of the parameters within the interface data model, where if the tests pass, then the sentences are displayed and if not they are hidden. In order to create a test batch onw would do as follows: First, Choose a query test 162 from the testing library 161 of the testing processor 155 processing engine 152 (herein termed the Method (7)—Step(1) 651). Then, Associate one or more interface module query 147 with a specific query test 162, (herein termed the Method (7)—Step(2) 652). Finally, Iteratively, repeat from Step 651 until the sentence module test batch 142 is capable of adequately expressing the desired conditions upon which an output sentence 151 would be generated when an interface data model 157 is examined with the processing engine 152, (herein termed the Method (7)—Step(3) 653). The aforementioned method is herein termed Method (7) 650. While the steps in Method (7) 650 are depicted in a particular order, the principles of the present disclosure are not limited to the order depicted immediately above. Additionally, embodiments of the Method (7) 650 process can include more or less steps than those depicted.

The term sentence module test batch 142 is thought to encompass a collection of one or more query test 162 associated with a sentence module 139, where if all tests in the batch pass, than the sentence module 139 will have a passing state or if it any fail, will have a failing state. The term disclosure application writer 150 is thought to encompass 1) a module that evaluates whether or not a sentence module 139 has passed a test and should be displayed 2) a module that constructs an output sentence 151 to a presentation layer 6 that is composed of one or more template sentence portion 140 3) a module that communicates with the processing engine 152 in order to extract the values from a interface data model 157 for each query template sentence portion 146 4) an entity that communicates with the processing engine 152 in order to extract the values from a interface data model 157 for each query template sentence portion 146 and inserting those values into the output sentence 151. The term output sentence 151 is thought to encompass a means for traversing tree data, which allows relative determination of the properties of one or more node within a tree data structure starting from a particular node.

The Step 553 which translates the user input into text can involve a processing engine do monitor the user input, and update in real time or other methods to bulk translate the text at once. Generally this is done by the disclosure application writer 150, which helps to perform the step. One aim of the disclosure application writer 150 is to have a means to examine to parse and evaluate the disclosure data 13 and algorithmically choose the appropriate patent text based on the instance of data, (i.e. an element, the types and number of limitations, and the types and numbers of its parent and child relationships).

In an embodiment where the input data is monitored and updated with sentences in real time, a processing engine can be created which would preferably comprise, the query language 153, the query language processor 154, the testing processor 155, the interface module converter 156, and the interface data model 157. In turn the testing processor 155 comprises a sub-item, the testing library 161 which in turn has one or more tests defined herein as the query test. These query tests match the query tests in the sentence module so that a determination can be made whthere to display a sentence based on the interface model state.

The term query language 153 is thought to encompass a means for traversing tree data, which allows relative determination of the properties of one or more node within a tree data structure starting from a particular node Alternatively, in other embodiments of the invention the query language 153 may be a xpath 158, a jquery 159, or a custom tree language 160

Create the processing engine would go as follows: First, assign a query language 153 to a processing engine 152 (herein termed the Method (8)—Step(1) 676 Then, Create a testing library 161 of one or more query test 162, (herein termed the Method (8)—Step(2) 677). Next, Create a means for inputting an interface data model 157, (herein termed the Method (8)—Step(3) 678). Then, Create a means for inputting a sentence module 139 from a sentence module library 130, (herein termed the Method (8)—Step(4) 679). Next, Create a means for extracting data from an interface data model 157 by an interface module query 147 as a pointer to the value, (herein termed the Method (8)—Step(5) 680). Next, Create a means to iterate over a sentence module test batch 142, (herein termed the Method (8)—Step(6) 681). Finally, Create a means to evaluate all the sentence module test 149 and indicate whether the sentence module 139 itself has passed the test, (herein termed the Method (8)—Step(7) 682). The aforementioned method is herein termed Method (8) 675. While the steps in Method (8) 675 are depicted in a particular order, the principles of the present disclosure are not limited to the order depicted immediately above. Additionally, embodiments of the Method (8) 675 process can include more or less steps than those depicted.

The query test 162 may or may not be in a library and may comprises one or more of the following: the element test 163, the limitation test 164, the scope test 165, and the number test 166. In some embodiments, the element test, limitation test, scope test and number test, may be supplanted by simple tests that test the presence, number, or absence of values pulled from an interface data model by a query.

The element test 163 has several sub steps for using it which are as follows: the disclosure application writer 150 initiates the type test 167 and makes a narrative determination 51 (herein termed the Method (9)—Step(1) 701 Next, if the element test 163 indicates the part 58, the disclosure application writer 150 initiates the part test 168 and makes a narrative determination 51, (herein termed the Method (9)—Step(2) 702). Next, the disclosure application writer 150 initiates the composition test 169 and makes a narrative determination 51, (herein termed the Method (9)—Step(3) 703). Next, the disclosure application writer 150 initiates the number test 166 regarding the instance element and makes a narrative determination 51, (herein termed the Method (9)—Step(4) 704). Finally, the disclosure application writer 150 initiates the Method (600) after the element test 163, (herein termed the Method (9)—Step(5) 705). The aforementioned method is herein termed Method (9) 700. While the steps in Method (9) 700 are depicted in a particular order, the principles of the present disclosure are not limited to the order depicted immediately above. Additionally, embodiments of the Method (9) 700 process can include more or less steps than those depicted. The element test 163 consists of 3 sub-items; the type test 167, the part test 168, and the composition test 169.

The limitation test 164 has several sub steps for using it which are as follows: the disclosure application writer 150 initiates a limitation type test 185 and for each limitation 50 makes a narrative determination 51 (herein termed the Method (17)—Step(1) 901 Next, the disclosure application writer 150 initiates the number test 166 regarding the instance limitation and makes a narrative determination 51, (herein termed the Method (17)—Step(2) 902). Last, the disclosure application writer 150 initiates the Method (600) after the limitation test 164, (herein termed the Method (11)—Step(3) 903). The aforementioned method is herein termed Method (11) 900. While the steps in Method (17) 900 are depicted in a particular order, the principles of the present disclosure are not limited to the order depicted immediately above. Additionally, embodiments of the Method (17) 750 process can include more or less steps than those depicted. The limitation test 164 consists of solely one sub-part, called herein the limitation type test 185.

In some versions of the invention, functionally, the limitation type test 185 could be either a does this instance element have a purpose limitation 186, a does instance element have a dimension limitation 187, a does this instance element have a dimension range limitation 188, a does this instance element have an attachment limitation 189, or a does this instance element have a material limitation 190

The scope test 165 has several sub steps for using it which are as follows: First, the disclosure application writer 150 initiates a scope type test 191 and for each scope 9 instance makes a narrative determination 51 (herein termed the Method (11)—Step(1) 751). Then, the disclosure application writer 150 initiates the number test 166 regarding the instance scope-related parameter and makes a narrative determination 51, (herein termed the Method (11)—Step(2) 752). Finally, the disclosure application writer 150 initiates the Method (600) after the scope test 165, (herein termed the Method (11)—Step(3) 753). The aforementioned method is herein termed Method (11) 750. While the steps in Method (11) 750 are depicted in a particular order, the principles of the present disclosure are not limited to the order depicted immediately above. Additionally, embodiments of the Method (11) 750 process can include more or less steps than those depicted. The scope test 165 comprises solely one sub-item, the scope type test 191.

In some versions of the invention, functionally, the scope type test 191 could be either a does this instance element have an example related parameter 192, a does this instance element have an definition related parameter 193, a does this instance element have an analog related parameter 194, or a does this instance element have an absent related parameter 195. Also it is reasonable to contemplate that Step 528 may be replaced by the disclosure application 1 is stored in memory 229 as a module 8 on one or more server 18 connected to a network 67, herein termed method (2)—step(5) 530, in another embodiment.

After the disclosure application is distributed as in Step 502, such as downloading it, or loading a web site where it is extant, the components to build it can be called and unpacked, which has several sub steps for using it which are as follows: First, disclosure application import one or more interface module 72 (herein termed the Method (12)—Step(1) 776). Next, disclosure application import one or more sentence module library 130 associated with each interface module 72, (herein termed the Method (12)—Step(2) 777). Then, disclosure application parses the interface module 72 into the interface data model 157, and interface gui data 2, using the processing engine 152, (herein termed the Method (12)—Step(3) 778). Then, disclosure application creates one or more user interface 65 by processing the interface gui data 2, (herein termed the Method (12)—Step(4) 779). Finally, Wait for input from the user, (herein termed the Method (12)—Step(5) 780). The aforementioned method is herein termed Method (12) 775. While the steps in Method (12) 775 are depicted in a particular order, the principles of the present disclosure are not limited to the order depicted immediately above. Additionally, embodiments of the Method (12) 775 process can include more or less steps than those depicted.

In order to use the disclosure application some nominal steps may be as follows: First, inventor 3 creates a disclosure view 71 representing one or more element 46 of their invention (herein termed the Method (13)—Step(1) 801). Then, inventor 3 names their disclosure view 71 with name text 83 or step text causing the disclosure application 1 to store a reference that can be called with a reference signal 56, (herein termed the Method (13)—Step(2) 802). Next, inventor 3 adds one or more, limitation 50 or scope 9 within the disclosure view 71, (herein termed the Method (13)—Step(3) 803). Then, inventor 3 creates one or more new disclosure view 71 with a new view creator 79 establishing a visual hierarchical relationship between the old and new disclosure view 71, (herein termed the Method (13)—Step(4) 804). Last, inventor 3 iteratively repeats the steps by returning to Step 802, (herein termed the Method (13)—Step(5) 805). The aforementioned method is herein termed Method (13) 800. While the steps in Method (13) 800 are depicted in a particular order, the principles of the present disclosure are not limited to the order depicted immediately above. Additionally, embodiments of the Method (13) 800 process can include more or less steps than those depicted.

Besides arranging the element or step hierarchy one can input data into the limitation view as in Step 803 which has several sub steps for using it which are as follows: First, inventor 3 uses the limitation view 75 to input one or more limitation 50 of their element 46 by assessing the limitation lead in text 87 for the proper phrasing. Then the inventor 3 inputs the limitation 50 value into the limitation field 86 and if desired, may use an reference signal 56 to refer to a previously input part 58 or step 59 (herein termed the Method (14)—Step(1) 826) and then subsequently inventor 3 uses the scope view 76 to input one or more scope 9 of their element 46 by assessing the scope lead in text 98 for the proper phrasing. Then the inventor 3 inputs the scope 9 value into the scope input field 10 and if desired, may use an reference signal 56 to refer to a previously input part 58 or step 59 (herein termed the Method (14)—Step(2) 827). The aforementioned method is herein termed Method (14) 825. While the steps in Method (14) 825 are depicted in a particular order, the principles of the present disclosure are not limited to the order depicted immediately above. Additionally, embodiments of the Method (14) 825 process can include more or less steps than those depicted.

When the user inputs the data as in Step 826 the processing engine allows updating and monitoring and changing of sentence in real time. This happens as follows: First, Upon entering information, interface data model 157 is updated by the system (herein termed the Method (15)—Step(1) 851). Next, The interface data model 157 is passed to the processing engine 152 by the system, (herein termed the Method (15)—Step(2) 852). Next, The processing engine 152 iterates over sentence module library 130 associated with the interface module 72 and examines whether the interface data model 157 matches conditions associated with any sentence module 139, (herein termed the Method (15)—Step(3) 853). Then, If there is a sentence module 139 that passes than output sentence 151 is created by the sentence output processor 24, (herein termed the Method (15)—Step(4) 854). Then, If there is a sentence module 139 that passes than output sentence 151 is created by the sentence output processor 24, (herein termed the Method (15)—Step(5) 855). Finally, user interface 65 displays one or more output sentence 151 that match the state of the interface data model 157, (herein termed the Method (15)—Step(6) 856). The aforementioned method is herein termed Method (15) 850. While the steps in Method (15) 850 are depicted in a particular order, the principles of the present disclosure are not limited to the order depicted immediately above. Additionally, embodiments of the Method (15) 850 process can include more or less steps than those depicted.

Alternatively, in the case of bulk evaluation of text input by the user an alternative method may be: First, disclosure application 1 compiles the invention information 62 generated from Step 504 into a disclosure data 13 (herein termed the Method (16)—Step(1) 876 Then, disclosure application writer 150 parses the disclosure data 13, (herein termed the Method (16)—Step(2) 877). Next, disclosure application writer 150 iteratively performs test for each element 46 to determine relationships between the elements and is returned one or more writer sentence 131, (herein termed the Method (16)—Step(3) 878). Then, disclosure application writer 150 concatenates writer sentences 11 using the sentence concatenator 129, (herein termed the Method (16)—Step(4) 879). Next, disclosure application writer 150 evaluates global text in the sentence concatenator 129 for reference signal 56 and replaces the text with their particular designations (with numbering, if necessary), (herein termed the Method (16)—Step(5) 880). Finally, disclosure application 1, (herein termed the Method (16)—Step(6) 881). The aforementioned method is herein termed Method (16) 875. While the steps in Method (16) 875 are depicted in a particular order, the principles of the present disclosure are not limited to the order depicted immediately above. Additionally, embodiments of the Method (16) 875 process can include more or less steps than those depicted. If Step 505 is missing, one can contemplate that the disclosure data 13 may be saved within a database 15, the disclosure data 13 may be saved as a file, or the disclosure data 13 may be transmitted across a network 67, for example in a client server model 16.

The invention comprises numerous terms that are necessary to define the scope of for purposes of interpretation. The definition of these terms below allows numerous embodiments of the invention that may arise, rather than just the preferred embodiment as described above. The term disclosure view 71 is thought to encompass a interactive view 35 within a graphical user interface 231 that is draggable and a crud object 60. The term element link 77 may include a graphical relationship between more than one disclosure view 71 that is representative of the relationships in a patent application 4 that is created by adding limitations.

The term limitation view 75 is broadly thought to include a means to allow the inventor to graphically denote one or more limitation 50 for a particular element 46. The term interface module 72 is broadly thought to include a data module that comprises one or more narrative module 108. The term narrative module hierarchy 106 is broadly thought to include the specific arrangement of narrative module 108 relative to one another that determines the order of message prompt 113 and the order of terms in an interface module query 147.

The term array reference 109 is broadly thought to include means for designating the name of the narrative module 108 so that it can be referenced by an interface module query 147. The term display properties 110 is broadly thought to include means for determining the properties of the limitation view 75 when built in the presentation layer 6. The term model reference 111 may include means for designating the narrative module 108 as part of the interface data model 157.

The term interface module query term reference 112 is thought to encompass means for designating the name of the narrative module 108 so that it can be referenced by an interface module query 147. The term message prompt 113 may include a portion of the presentation layer 6 associated with a narrative module 108 which prompts the user for information which would lead to input used to create the text of the patent application. The term interface module tree representation 107 is broadly thought to include a data representation of the interface module 72 and narrative module hierarchy 106 that can be queried with a query language 153 by the processing engine 152.

The term narrative output 127 may include the narrative constructed from one or more sentences. The term writer sentence 131 is thought to encompass After a series of narrative determination 51, there are an allotment of natural text 12 sentences to choose from that reflect the purpose of the element 46 in terms of patentability. This natural text 12 has both writer phrase 132 and writer noun 133. The term writer phrase 132 may include Within a writer sentence 131 are phrases that may be synonyms (are interchangeable) within the context of the writer sentence 131. These phrases may or may not be randomly selected to be inserted into the writer sentence 131 so that they can be substituted for enhanced readability.

The term template sentence portion 134 is broadly thought to include one or more portions of sentence module 139 that create an output sentence 151. The term text template sentence portion 135 is broadly thought to include portion of a sentence module 139 that contains text that effects the meaning of the output sentence 151. The term query template sentence portion 136 is thought to encompass portion of a sentence module 139 that necessarily links to a interface module 72 or narrative module 108 by a query language 153.

The term interface module query 137 is thought to encompass a string containing one or more interface module query term reference 112 linked by the syntax of the query language 153, wherein said querying the absence of user input or properties of user input, that is specific to the structure of the interface module 72 and the narrative module 108 nested within, and is composed of within query language 153. The term interface module query term 138 is thought to encompass a string that refers to one narrative module 108 by a property designated by the narrative module 108. The term sentence concatenator 129 is thought to encompass a holder for many writer sentence 131 that concatenates the writer sentence 131 into the text of the patent application 4.

The term sentence module library 130 may include a module 8 that exists in a database 15 on a server 18 or user device 66 which has one or more sentence module 139 and is associated with one or more interface module 72. The term template sentence portion 140 is thought to encompass one or more portions of sentence module 139 that create an output sentence 151. The term text template sentence portion 145 may include portion of a sentence module 139 that contains text that effects the meaning of the output sentence 151.

The term query template sentence portion 146 may include portion of a sentence module 139 that necessarily links to a interface module 72 or narrative module 108 by a query language 153. The term interface module query 147 is thought to encompass a string containing one or more interface module query term reference 112 linked by the syntax of the query language 153, wherein said querying the absence of user input or properties of user input, that is specific to the structure of the interface module 72 and the narrative module 108 nested within, and is composed of within query language 153. The term interface module query term 148 may include a string that refers to one narrative module 108 by a property designated by the narrative module 108.

The term sentence library reference 141 is thought to encompass a property of the sentence module 139 that allows it to be referenced as a singular entity. The term sentence module test batch 142 is thought to encompass a collection of one or more query test 162 associated with a sentence module 139, where if all tests in the batch pass, than the sentence module 139 will have a passing state or if it any fail, will have a failing state. The term sentence module passing state reference 143 is broadly thought to include a reference that an output sentence 151 should be produced.

The term sentence module failing state reference 144 is broadly thought to include a reference that an output sentence 151 should not be produced. The term disclosure application writer 150 is thought to encompass 1) a module that evaluates whether or not a sentence module 139 has passed a test and should be displayed 2) a module that constructs an output sentence 151 to a presentation layer 6 that is composed of one or more template sentence portion 140 3) a module that communicates with the processing engine 152 in order to extract the values from a interface data model 157 for each query template sentence portion 146 4) an entity that communicates with the processing engine 152 in order to extract the values from a interface data model 157 for each query template sentence portion 146 and inserting those values into the output sentence 151. The term output sentence 151 is thought to encompass a means for traversing tree data, which allows relative determination of the properties of one or more node within a tree data structure starting from a particular node.

The term query language 153 is thought to encompass a means for traversing tree data, which allows relative determination of the properties of one or more node within a tree data structure starting from a particular node. The term query language processor 154 is thought to encompass a means for evaluating the presence of a value in one or more interface data model 157 with one or more query language 153. The term element test 163 is broadly thought to include a group of tests that are iteratively applied to the disclosure data 13 to determine the nature, relationships and number of elements by making a sequence of narrative determination 51 that lead to a writer sentence 131 being created.

The term type test 167 may include a test of the properties of the element 46 input into the disclosure view 71 that determines its nature as a part or a step and whether its parent element 46 (based on its element association 5 is a part 58 or a step 59 which to a narrative determination 51. The term part test 168 is thought to encompass a test of the properties of the element 46 input into the disclosure view 71 (that has already been determined to ba a part 58 rather than a step 59) and to determine whether it is physical feature of the part 58 rather than the part itself, which leads to a narrative determination 51. The term composition test 169 may include a test of the properties of the element 46 input into the disclosure view 71 that determines its nature as a part or a step and whether it's parent element 46 (based on its element association 5 is a part 58 or a step 59 which to a narrative determination 51.

The term number test 166 is broadly thought to include a test of the properties of the element 46 input into the disclosure view 71 (that has already been determined to ba a part 58 rather than a step 59) and to determine whether it is physical feature of the part 58 rather than the part itself, which leads to a narrative determination 51. The term interface data model 157 is thought to encompass a data representation of one or more specific designated narrative module 108 within in the interface module 72 that create a interface data model 157 after being processed by the interface module converter 156. The term disclosure application 1 may include software 23 or module 8 in a presentation layer 6 on a user device 66 that allows rapid, input of invention information 62 and outputs patent application text.

The term interface gui data 2 may include the information extracted from the interface module 72 which is used to create linked portions of the presentation layer 6, which may include the disclosure view 71, limitation view 75 and message prompt 113. The term inventor 3 is thought to encompass any person, or persons in United States patent law, who contribute to the claims of a patentable invention. The term patent application 4 is thought to encompass a request pending at a patent office for the grant of a patent for the invention described and claimed within the application.

The term element association 5 is thought to encompass the nested relationship between one or more disclosure view 71 (of possibly different types, such as method having steps or step having sub step or step having element) which may determine different type of sentences generated. The term presentation layer 6 is thought to encompass graphical output from a module 8 for user interaction typically one or more graphical user interface 231. The term view 35 is thought to encompass a portion of presentation layer 6 module typical to model view controller architecture.

The term module 8 is thought to encompass instructions hosted on memory 229 executed by the cpu 22 which perform functions. The term scope 9 is thought to encompass reference of the variation in the possible embodiments of a particular element 46 or means plus function element 46. The term scope input field 10 may include portion of the presentation layer 6 that allows scope 9 data to be input by the user.

The term writer sentences 11 is thought to encompass one or more sentences displayed for the user in a presentation layer 6. The term natural text 12 may include text generated from the invention that describes the inventor 3 invention. The term disclosure data 13 is thought to encompass the instance or sum result of input into one or more disclosure view 71 translated into a structured data format that can be queried or parsed.

The term developer 14 is thought to encompass any person involved with researching, designing, implementing, and/or testing software 23. The term database 15 is thought to encompass an organized collection of data with a software system designed to allow the definition, creation, querying, update, and administration of databases. The term client server model 16 is broadly thought to include structure in computing that partitions tasks or workloads between the providers of a resource or service, called servers, and service requesters, called clients.

The term server side 17 is thought to encompass operations that are performed by the server in a client-server relationship in computer networking. The term server 18 is broadly thought to include a system (software and suitable computer hardware) that responds to requests across a computer network and has a cpu 22 capable of executing one or more instructions on one or module 8 present on memory 229. The term computer network 19 is broadly thought to include a telecommunications network that allows computers to exchange data.

The term program 20 may include a sequence of instructions, written to perform a specified task with a computer that is executed by the central processing unit 228. The term memory 229 may include the physical devices used to store programs (sequences of instructions) or data (e.g. program state information) on a temporary or permanent basis for use in a computer or other digital electronic device. The term operating system 230 is thought to encompass a collection of software that manages computer hardware resources and provides common services for computer programs.

The term graphical user interface 231 may include a type of user interface that allows users to interact with electronic devices through graphical icons and visual indicators such as secondary notation, as opposed to text-based interfaces, typed command labels or text navigation. The term software 23 is thought to encompass a collection of computer programs and related data. The term sentence output processor 24 may include a module 8 which renders a sentence module 139 into text that is displayed for one or more users.

The term markup language 25 is broadly thought to include a modern system for annotating a document in a way that is syntactically distinguishable from the text. The term web site 26 is thought to encompass a set of related web pages served from a single web domain. The term client 27 may include a piece of computer hardware or software that accesses a service made available by a server.

The term web browser 28 is broadly thought to include a software application for retrieving, presenting and traversing information resources on the internet. The term web page 29 is broadly thought to include a web document that is suitable for the internet and the web browser. The term programming language 30 may include an artificial language designed to communicate instructions to a machine, particularly a computer.

The term object oriented programming 31 is broadly thought to include a programming paradigm that represents concepts as objects that have data fields (attributes that describe the object) and associated procedures known as methods. The term objects 32 is thought to encompass an instance of a class. The term method 57 is broadly thought to include one or step 59 that perform a function in the invention.

The term view 35 may include a portion of presentation layer 6 module typical to model view controller architecture. The term disclosure 36 may include a traditional document written by an inventor or ally of an inventor, or an interactive program 20 such as the disclosure application 1 which may include one or more instances of invention information 62 for describing an invention. The term icon 38 is broadly thought to include a pictogram displayed on a computer screen in order to help a user navigate a graphical user interface 231 on a computer 21.

The term disclosure data format 39 is broadly thought to include a data format used for storing one or more element 46 of invention information 62, this may be a markup language 25 or file, for example. The term purpose limitation 40 may include when describing an element 46, which can be a part 58 or a step 59 and evaluating the reason for its inclusion into the invention, it helps to have a reason to distinguish its non-obviousness if a result of various combinations of one or more element 46. Including one or more purposes assigned to an element 46, help both the inventor and examiner look at its function, role, and non-obvious relations to other elements, which can determine it&#x27;s relationships to references in the prior art. This limitation 50 can be assigned to each element 46 in a disclosure view 71. The term attachment limitation 41 may include when describing an element 46, that is a part 58 and evaluating the reason for its inclusion into the invention, it helps to have examine what other element 46 in may be attached to (and the mechanism of attachment). This allows the inventor and examiner look more closely at its structural relationships, which can be used to show or evaluate non-obviousness of the invention as a whole. This limitation 50 can be assigned to each element 46 in a disclosure view 71.

The term material limitation 42 is broadly thought to include when describing an element 46, that is a part 58 and evaluating the reason for its inclusion into the invention, it helps to know the preferred embodiment composition of the material, which can be used to show or evaluate non-obviousness of the invention as a whole. This limitation 50 can be assigned to each element 46 in a disclosure view 71. The term position limitation 43 is broadly thought to include when describing an element 46, that is a part 58 and evaluating the reason for its inclusion into the invention, it helps to have this input to examine how other part 58 are spatially arranged relative to the part 58. This allows the inventor and examiner look more closely at its spatial relationships, which can be used to show or evaluate non-obviousness of the invention as a whole. This limitation 50 can be assigned to each element 46 in a disclosure view 71. The term dimension limitation 44 may include a vector measurement of physical entity (or space) that is a limitation 50 of an part 58. when describing an element 46, that is a part 58 and evaluating the reason for its inclusion into the invention, it helps to have this input to examine the size of a dimension in the preferred embodiment of the part 58. This limitation 50 can be assigned to each element 46 in a disclosure view 71.

The term dimension range limitation 45 is broadly thought to include the in-between values of a minimum and maximum dimension limitation 44 that functionally pertain to a part 58. When describing an element 46, that is a part 58 and evaluating the reason for its inclusion into the invention, it helps to have this input to examine the range of size of a dimension in the preferred embodiment (and other embodiments) of the part 58. This limitation 50 can be assigned to each element 46 in a disclosure view 71. The term element 46 may include an item in an invention that can possibly have sub-items (which are not solely limitation 50). The term subpart composition 47 is thought to encompass the in-between values of a minimum and maximum dimension limitation 44 that functionally pertain to a part 58. When describing an element 46, that is a part 58 and evaluating the reason for its inclusion into the invention, it helps to have this input to examine the range of size of a dimension in the preferred embodiment (and other embodiments) of the part 58. This limitation 50 can be assigned to each element 46 in a disclosure view 71.

The term method composition 48 is thought to encompass the in-between values of a minimum and maximum dimension limitation 44 that functionally pertain to a part 58. When describing an element 46, that is a part 58 and evaluating the reason for its inclusion into the invention, it helps to have this input to examine the range of size of a dimension in the preferred embodiment (and other embodiments) of the part 58. This limitation 50 can be assigned to each element 46 in a disclosure view 71. The term step composition 49 is thought to encompass the in-between values of a minimum and maximum dimension limitation 44 that functionally pertain to a part 58. When describing an element 46, that is a part 58 and evaluating the reason for its inclusion into the invention, it helps to have this input to examine the range of size of a dimension in the preferred embodiment (and other embodiments) of the part 58. This limitation 50 can be assigned to each element 46 in a disclosure view 71. The term limitation 50 is broadly thought to include a claimable part of an invention which defines the invention. Includes any property of a part (including it&#x27;s sub-parts), and any property of a step (including it&#x27;s sub-steps) and can be mapped out to a narrative module 108 in an interface module 72.

The term narrative determination 51 is thought to encompass a logical decision point based on the instance element and its relationships, limitations etc. It limits the potential types of writer sentence 131 that can be used in the patent application 4 text. The term drawing representative relationship 52 may include a relationship that represents a disclosure view 71 as superimposed over the patent drawing 68 as the part 58 or step 59, wherein the disclosure view 71 resembles a numbered element and lead line in a patent drawing 68. The term element reference 53 may include have a means to refer to an element and its supporting properties, rather than the just the text of an element, which is used to for numbering.

The term shorthand reference 54 may include a way to refer to an element that is a step 59, not by the step text 84 but rather by a shorthand method referring to that step 59. The term element step 55 is broadly thought to include a step for doing some action that may be claimable such as in a system or method patent. The term method 57 is broadly thought to include one or step 59 that perform a function in the invention.

The term part 58 may include a functional physical component of an invention. The term step 59 may include an action that is performed in an invention. The term crud object 60 may include an acronym for create, read, update and delete graphical user interface 231 objects which are the four basic functions of persistent storage. Also pertains to graphical user interface 231 conventions that facilitate viewing, searching, and changing information for computer 21 forms and reports.

The term invention information 62 is thought to encompass data related to the function, composition, creation, use, or description of an invention including any claimable limitation. The term iterative disclosure views 63 may include a graphical representation of the nested hierarchy of disclosure view 71 which is related to the comprises and consists of language in patent claims in generating the text. The term user input 64 is broadly thought to include text or information that is input by the user into one or more module 8 presentation layer 6.

The term user interface 65 is broadly thought to include a display mechanism for a graphical user interface 231 which in turn is part of the presentation layer 6 of one or more module 8. The term user device 66 may include an interactive device that has a cpu 22 and memory 229 with one or more module 8 containing executable instructions, typically a computer 21. The term network 67 is thought to encompass a telecommunications network that allows computers to exchange data.

The term patent drawing 68 is thought to encompass a drawing required for ascertaining intellectual property, for example which may be a nonprovisional patent drawing 69 or a provisional patent drawing 70. The term nonprovisional patent drawing 69 may include a drawing that is labeled with numbers representing invention elements or steps or tables that corresponds to the requirements of drawings for the USPTO non provisional application or PCT application. The term provisional patent drawing 70 is broadly thought to include a drawing that is labeled with numbers representing invention elements or steps or tables that is used for filing a provisional patent.

1) I claim a system for patent application preparation comprising:
a computer with a microprocessor,
an interface on said computer,
multiple disclosure views on said interface wherein said disclosure views receive invention information from a user and are rearrangable on said interface
a means for compiling said invention information into sentences.

2) I claim a method for preparing patent applications comprising:
using a computer interface with multiple disclosure views wherein said disclosure views,
receiving invention information from a user and are rerearrangable on said interface
compiling said invention information into the text of a patent application.
